(19) United States
(12) Patent Application Publication
(10) Pub. No.: US 2017/0058852 A1
(43) Pub. Date: Mar. 2, 2017

(54) STARTER FOR ENGINE

(71) Applicant: DENSO CORPORATION, Kariya-city (JP)

(72) Inventors: Yoshito TAKAGI, Kariya-city (JP); Eitaro TANAKA, Kariya-city (JP); Kazuya ENOKIZONO, Kariya-city (JP)

(73) Assignee: DENSO CORPORATION, Kariya-city (JP)

(21) Appl. No.: 15/249,958

(22) Filed: Aug. 29, 2016

(30) Foreign Application Priority Data
Aug. 27, 2015 (JP) 2015-167743
Feb. 10, 2016 (JP) 2016-023461
Jun. 16, 2016 (JP) 2016-119940

(51) Int. Cl. F02N 11/02; F02N 15/02; F02N 15/00

(52) U.S. Cl. CPC F02N 11/02; F02N 15/003; F02N 15/022

(57) ABSTRACT

A starter for an engine is provided which includes an electromagnetic brake device and a pinion thrust mechanism. The electromagnetic brake device holds a planetary carrier from rotating. The pinion thrust mechanism converts rotational motion of an internal gear into linear motion of a pinion when the rotation of the planetary carrier is locked. The pinion thrust mechanism includes a cylindrical cam cylinder, a starter housing, a thrust collar rotatable relative to the pinion, and an engaging pin. The cam cylinder is joined to the internal gear and has a circumferential extending cam groove. The starter housing has a straight groove traversing the cam groove. The engaging pin engages both the cam groove and the straight groove and is moved linearly with rotation of the cam cylinder. This enables the linear movement of the pinion regardless of a helix angle of the spline mounted on the output shaft.

### CROSS REFERENCE TO RELATED DOCUMENT

The present application claims the benefit of priority of Japanese Patent Application No. 2015-167743 filed on Aug. 27, 2015. No. 2016-23461 filed on Feb. 10, 2016, and No. 2016-119940 filed on Jun. 16, 2016, disclosures of which are incorporated herein by reference.

### BACKGROUND

1 Technical Field

This disclosure relates generally to a starter for an engine.

2 Background Art

For instance, Japanese Patent First Publication No. H8-177691 discloses an engine starter which includes a pinion clutch which engages a helical spline mounted on an output shaft of an electric motor and rotation braking members which are attracted by a field coil, as energized by an external device, and then pressed against an outer circumference of the pinion clutch. The rotation of the output shaft of the motor when the pinion clutch is held from rotating by the rotation braking members causes the pinion clutch to be moved on the output shaft away from the motor with the aid of the operation of the helical spline to establish engagement of a pinion with a ring gear of the engine.

The engine starter is, as apparent from the above discussion, engineered to use the operation (which will also be referred to as feed screw motion below) of the helical spline, as developed by the rotation of the output shaft, to move the pinion clutch away from the motor. The helical spline is, therefore, indispensable and impossible to replace with a straight spline. When the helix angle of the helical spline is small, it may result in a failure of the feed screw motion or require a great degree of torque for thrusting the pinion clutch, in other words, it may result in an increased degree of torque need to press the rotation braking members against the outer circumference of the pinion clutch to apply a brake to the rotation of the pinion clutch.

Further, the pressing of the rotation braking members against the outer circumference of the pinion clutch to suppress the rotation of the pinion clutch leads to a problem that a loss of sliding motion of the pinion clutch on the output shaft occurs, thereby resulting in an increased consumption of electric power in the motor.

### SUMMARY

It is therefore an object to provide a starter which is capable of thrusting a pinion in an axial direction using rotation of an electric motor regardless of a helix angle of a spline provided on an output shaft.

According to one aspect of the invention, there is provided a starter which may be employed in starting an internal combustion engine mounted in automobiles. The starter comprises: (a) an electric motor which is supplied with electrical power to produce torque; (b) a power split device which works to distribute the torque inputted from the motor to a first power transmission system and a second power transmission system, the power split device having a first output from which the torque distributed to the first power transmission system is outputted and a second output from which the torque distributed to the second power transmission system is outputted; (c) an output shaft which is rotated by the torque which is outputted from the first output and transmitted to the output shaft; (d) a pinion which engages an outer periphery of the output shaft through a spline and is movable on the output shaft in an axial direction thereof; (e) a pinion thrust mechanism which includes a cam cylinder which is rotated by the torque which is outputted from the second output and transmitted to the cam cylinder, the pinion thrust mechanism working to convert rotational motion of the cam cylinder into linear motion of the pinion; and (f) an electromagnetic brake device which includes a brake plate which is made of ferromagnetic material and is joined to the first output of the power split device, the electromagnetic brake device working to use magnetic force to hold the brake plate from rotating.

The starter is capable of converting the rotational motion of the cam cylinder into the linear motion the pinion undergoes through the pinion thrust mechanism. This moves the pinion in the axial direction of the starter without use of the feed screw motion provided by the helical spline on the output shaft. For example, the movement of the pinion in the axial direction may be accomplished by mounting a straight spline on the output shaft and moving the pinion with the aid of an operation of the pinion thrust mechanism which engages the straight spline. This achieves the movement of the pinion in the axial direction regardless of the helix angle of the spline. In this disclosure, a spline whose helix angle is zero degree will be referred to as a straight spline.

The above arrangements also obviates the need for pressing, the outer circumference of the pinion to hold the pinion from rotating when it is required to slide the pinion along the output shaft, thus resulting in a decrease in loss of sliding motion of the pinion as compared with the conventional starter, as described above, which will lead to a decrease in consumption of electrical energy in the motor.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which illustrates a starter according to the first embodiment;

FIG. 2 is an exploded perspective view which illustrates a starter equipped with a planetary gear train and a clutch according to the first embodiment;

FIG. 3 is an exploded perspective view which illustrates a magnetic force generator and peripheral parts thereof in a starter in the first embodiment;

FIG. 4 is an exploded perspective view which illustrates a pinion thrust mechanism and peripheral parts thereof in a starter in the first embodiment;

FIG. 5 is an explanatory view which demonstrates an operation of a starter when a pinion is at rest in the first embodiment;

FIG. 6 is an explanatory view which demonstrates an operation of a starter when a pinion is moving in the first embodiment;

FIG. 7 is an explanatory view which demonstrates an operation of a starter when a pinion has been moved by a maximum distance;

FIG. 8 is a sectional view which illustrates a starter except an electrical motor according to the second embodiment;

FIG. 9 is a perspective view which illustrates major parts of a starter in the second embodiment;

FIG. 10 is a sectional view which illustrates a starter except an electrical motor according to the third embodiment;

FIG. 11 is a perspective view which illustrates major parts of a starter in the third embodiment;

FIG. 12 is a sectional view which illustrates a starter according to the fourth embodiment;

FIG. 13 is a perspective view which illustrates major parts of a starter in the fourth embodiment;

FIG. 14 is a sectional view which illustrates a starter according to the fifth embodiment;

FIG. 15 is an exploded perspective view which an electromagnetic brake device and an electromagnetic clutch in the fifth embodiment;

FIG. 16 is a sectional view which illustrates an electromagnetic brake device and an electromagnetic clutch in the fifth embodiment;

FIG. 17 is a nomograph which demonstrates an operation of a planetary gear train in the fifth embodiment;

FIG. 18 is a nomograph which demonstrates an operation of a planetary gear train in the fifth embodiment;

FIG. 19 is a nomograph which demonstrates an operation of a planetary gear train in the fifth embodiment;

FIG. 20 is a sectional view which illustrates a starter according to the sixth embodiment;

FIG. 21 is an exploded perspective view which illustrates an electromagnetic brake device and an electromagnetic clutch in the sixth embodiment;

FIG. 22 is a sectional view which illustrates a starter according to the seventh embodiment;

FIG. 23 is a sectional view which illustrates a differential gear unit and peripheral parts thereof in the seventh embodiment;

FIG. 24 is an exploded perspective view which illustrates an electromagnetic brake device, an electromagnetic clutch, and a differential gear unit in the seventh embodiment;

FIG. 25 is a sectional view which demonstrates an operation of an electromagnetic brake device in the seventh embodiment;

FIG. 26 is a sectional view which demonstrates an operation of an electromagnetic clutch in the seventh embodiment;

FIG. 27 is a sectional view which illustrates a starter except an electrical motor according to the eighth embodiment;

FIG. 28 is a perspective view which illustrates a brake plate in the eighth embodiment;

FIG. 29 is a perspective view which illustrates a magnetic pole-bearing member of a starter in the eighth embodiment;

FIG. 30 is an enlarged sectional view of a portion of FIG. 27, as indicated by an arrow A, which demonstrates a flow of magnetic flux in an electromagnetic brake device installed in a starter in the eighth embodiment; and

FIG. 31 is an enlarged sectional view of a portion of FIG. 27, as indicated by an arrow A, which demonstrates a flow of magnetic flux in a rotation stopper mechanism installed in a starter in the eighth embodiment.

### DESCRIPTION OF THE PREFERRED EMBODIMENT

### First Embodiment

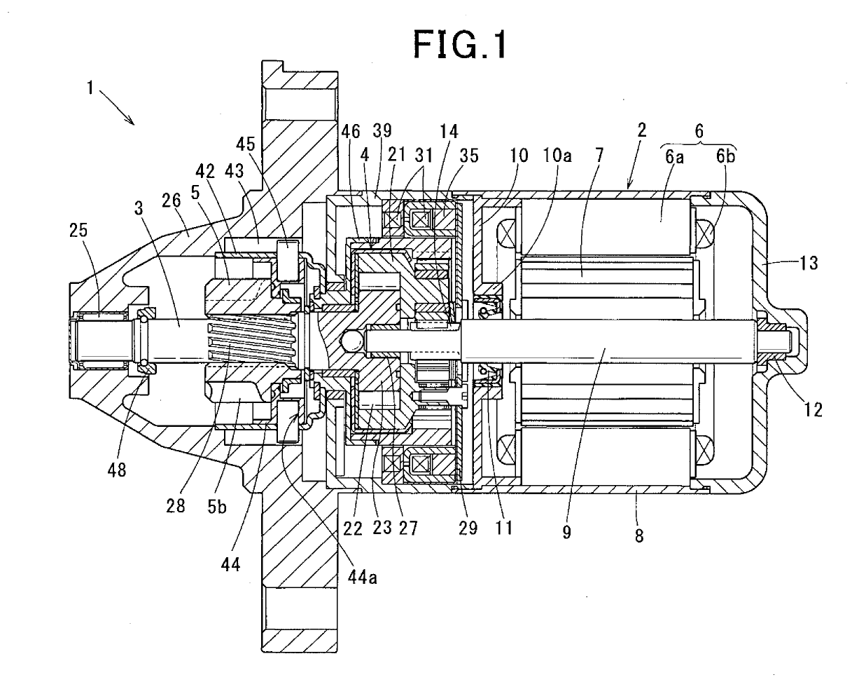

Referring to the drawings, wherein like reference numbers refer to like parts in several views, particularly to FIG. 1, there is shown the starter 1 according to the first embodiment. The starter 1 includes the electric motor 2, the planetary gear train, the output shaft 3, the clutch 4, the pinion 5, the electromagnetic brake device, and the pinion thrust mechanism.

The motor 2 is, as illustrated in FIG. 1, an AC motor which is equipped with the stator 6 and the rotor 7 and capable of rotating both in a normal direction and in a reverse direction. The stator 6 is equipped with the stator core 6a secured to an inner circumference of the yoke 8 which defines an outer shell and the three-phase armature winding 6b which is wound around the stator core 6a. The stator 6 works to produce a rotating magnetic field upon application of an AC three-phase current to the armature winding 6b through an inverter (not shown). The rotor 7 may be of an interior permanent magnet type which has permanent magnets embedded in an iron core meshing with an outer circumference of a rotating shaft (which will also referred to below as a motor shaft 9) of the motor 2 or a surface permanent magnet type which has permanent magnets affixed to the outer surface of an iron core. The rotor 7 rotates synchronously with the rotating magnetic field. The rotor 7 may alternatively be implemented by a rotor of a salient pole type using no permanent magnet.

The yoke 8 has the motor partition wall 10 formed on a portion of an inner periphery closer to one end thereof to isolate space (which will also be referred to as a motor chamber) in which the stator 6 and the rotor 7 are disposed from the planetary gear train. The motor partition wall 10 is oriented perpendicular to a radial direction of the motor shaft 9 and has the boss 10a formed on the radial center thereof. The boss 10a has mounted on an inner periphery thereof the oil seal 11 which hermetically seal an outer circumference of the motor shaft 9. The motor shaft 9 has an end which passes through an inner periphery of the oil seal 11 and protrudes from the motor partition wall 10 away from the motor 2 (i.e., to the left in FIG. 1) and the other end which is retained by the end frame 13 to be rotatable through the bearing 12 (also called a shaft bush).

In the following discussion to refer to component parts of the starter 1, a portion of each component part which is farther away from the motor 2 will be also referred to as an opposite motor side (i.e., the left side in FIG. 1), while another portion closer to the motor 2 will also be referred to as a motor side (i.e., the right side in FIG. 1). Additionally, a direction which is oriented away from the motor 2 will also be referred to as an opposite motor direction, while a direction which is oriented closer to the motor 2 will also be referred to as a motor direction.

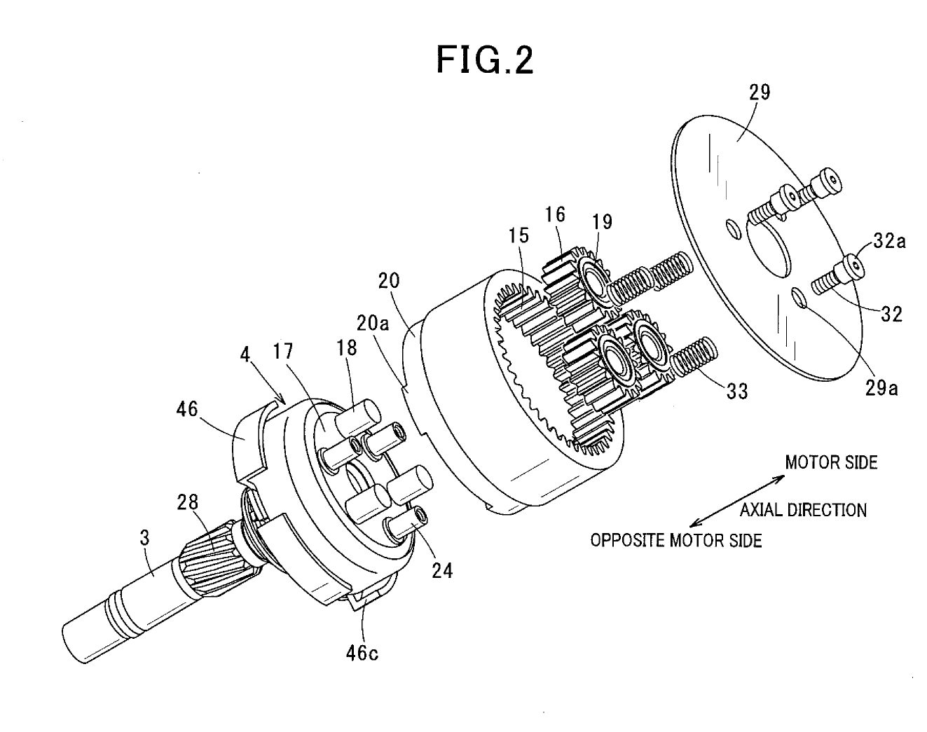

The planetary gear train is, as can be seen in FIGS. 1 and 2, made up of the sun gear 14 mounted on the motor shaft 9, the internal gear 15 (also called a ring gear) which is arranged rotatably and coaxially with an axis of rotation of the sun gear 14, the planetary gears 16 which mesh with the sun gear 14 and the internal gear 15 to be rotatable about their own axes and revolvable or orbitable around the sun gear 14, and the planetary carrier 17 which outputs the orbital motion of the planetary gears 16. The planetary carrier 17 will also be referred to as a first output of a power split device, as will be described later in detail. The internal gear 15 will also be referred to as a second output of the power split device.

The sun gear 14 is formed integrally with an end portion of the motor shaft 9 which protrudes from the motor partition wall 10 to the opposite motor side and rotatable along with the motor shaft 9. The sun gear 14 may be machined as a discrete part which is press-fit on the motor shaft 9 or fixed on the motor shaft 9 through serrations.

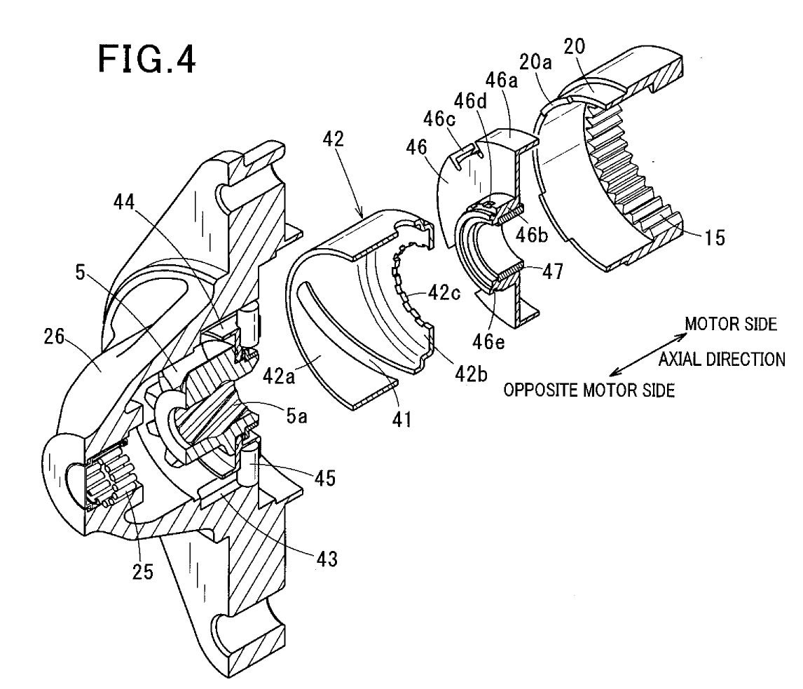

The internal gear 15, as illustrated in FIG. 4, has the cylindrical wall 20 integrally formed therewith. The cylindrical wall 20 is located farther away from the motor 2 than the internal gear 15 (i.e., internal tooth) is. The cylindrical wall 20 has an outer shoulder formed on the middle thereof in the axial direction of the internal gear 15. Specifically, the cylindrical wall 20 has two portions: a large-outer diameter portion and a small-outer diameter portion. The large-outer diameter portion is located closer to the motor 2 than the small-outer diameter portion is (i.e., the motor side). The small-outer diameter portion is smaller in wall thickness than the large-outer diameter portion. The cylindrical wall 20 also has a plurality (four in this embodiment) of positioning protrusions 20a formed on an end surface of the small-outer diameter portion.

The planetary gears 16 are retained rotatably through bearings 19 by the planetary gear pins 18 disposed on the planetary carrier 17. The planetary gears 16 are, as can be seen in FIG. 2, arranged at equal intervals away from each other in a circumferential direction of the internal gear 15.

The planetary carrier 17 is formed integrally with the outer 21 of the clutch 4 which will be described later in detail and rotated by the orbital motion of the planetary gears 16. The clutch 4 is made of a one-way roller clutch to transmit torque from the outer 21 to the inner 23 through the rollers 22 arranged in cam chambers and also block transmission of torque from the inner 23 to the outer 21. The clutch 4 may alternatively be implemented by a one-way sprag clutch.

The outer 21 is formed integrally with the planetary carrier 17 by, for example, cold forging. When the planetary carrier 17 and the planetary gear pins 18 are formed integrally with the outer 21 by the cold forging, the degree of pressure required to drive punches to press material for forming the planetary gear pins 18 will be higher than that to form the planetary carrier 17 since the planetary gear pins 18 are each smaller in sectional area than the planetary carrier 17. This results in the risk that stress acting on dies increases, so that the service life of the dies will be shortened. In order to alleviate this drawback, the planetary carrier 17, as illustrated in FIG. 2, also has formed thereon as many dummy pins 24 as the planetary gear pins 18. Specifically, the number of the dummy pins 24 is the same (i.e., three) as the planetary gear pins 18. The dummy pins 24 are disposed at locations which do not mechanically interfere with the planetary gears 16. The use of the dummy pins 24 in addition to the planetary gear pins 18 results in an increased total sectional area of portions of the material pressed by the punches, which leads to a decreased degree of stress exerted on the dies to ensure a desired service life of the dies.

The output shaft 3 is arranged, as can be seen in FIG. 1, coaxially or in alignment with the motor shaft 9 and has an end on the opposite motor side thereof which is retained through the bearing 25 by the starter housing 26 to be rotatable and also has a large-diameter portion on the motor side thereof which defines the inner 23 of the clutch 4. The large-diameter portion of the output shaft 3 has formed therein a cylindrical bore which axially extends from the end of the output shaft 3 located on the motor side and in which the end of the motor shaft 9 is disposed through the bearing 27 to be rotatable relative to the output shaft 3. The output shaft 3 has the male helical spline 28 formed on a middle portion of a length thereof.

The pinion 5, as can be seen in FIG. 4, has the female helical spline 5a formed on an inner periphery thereof. The helical spline 5a meshes with the helical spline 28 of the output shaft 3 to be movable or slidable on the output shaft 3.

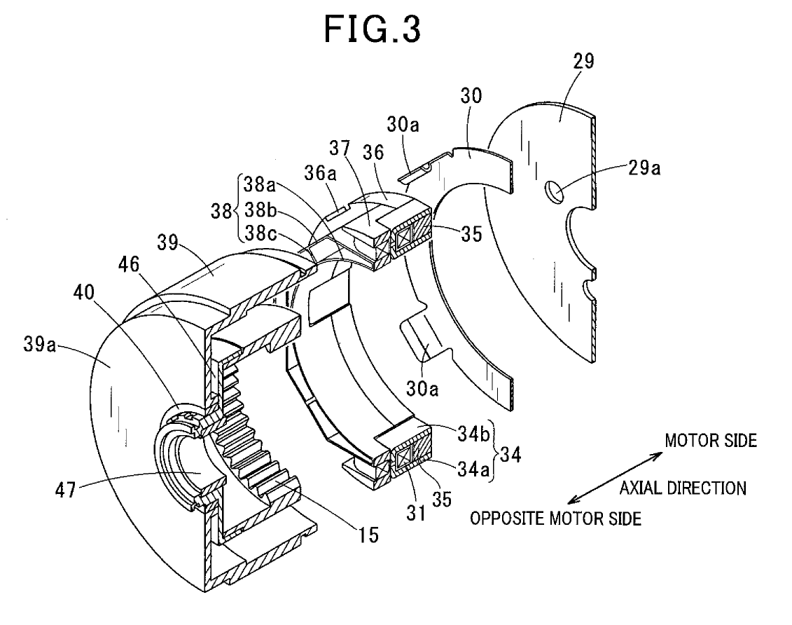

The electromagnetic brake device is, as illustrated in FIG. 3, equipped with the brake plate 29, the friction plate 30, a magnetic force generator (which will be described later in detail), and the brake release coils 31. The brake plate 29 is made of a ferromagnetic material such as an iron plate. The friction plate 30 faces an end surface of the brake plate 29 on the opposite motor side. The magnetic force generator works to magnetically attract the brake plate 29 through the friction plate 30. The brake release coils 31 work to cancel the magnetic force, as produced by the magnetic force generator.

The brake plate 29 is, as can be seen in FIG. 2, made of a circular plate which has formed therein three small-diameter holes 29a which are arranged in a circumferential direction thereof. The brake plate 29 extends in a radial direction of the motor shaft 3, that is, is oriented perpendicular to the motor shaft 9. The brake plate 29 is secured to the planetary carrier 17 by tightening the bolts 32 inserted into the small-diameter holes 29a to engage threaded bores formed in the dummy pins 24. This holds the brake plate 29 from rotating relative to the planetary carrier 17.

The brake plate 29 is not fully fixed to the dummy pins 24 using the bolts 32, but slightly movable by, for example, a few tenths of a millimeter in the axial direction thereof. Specifically, the brake plate 29 is movable between the position where the surface of the brake plate 29 on the opposite motor side contacts the friction plate 30 and the position where the surface of the brake plate 29 on the motor side which is farther away from the friction plate 30 contacts the back surfaces of the bolt heads 32a. The brake plate 29 is elastically urged away from the friction plate 30 by the coil springs 33.

The friction plate 30 is of a ring shape which has the same outer diameter as that of the brake plate 29 and disposed in contact with an axial end surface of the magnetic force generator, as will be described below. The friction plate 30 is held from rotating in a circumferential direction relative to the magnetic force generator.

The magnetic force generator, as illustrated in FIG. 3, includes a plurality of (four in this embodiment) brake magnetic pole units 34 and the permanent magnets 35. The brake magnetic pole units 34 are located on the opposite side of the friction plate 30 to the brake plate 29. The permanent magnets 35 magnetize the brake magnetic pole units 34.

The permanent magnets 35 are fixed by the positioning members 36 at four locations arrayed in a circumferential direction of the brake magnetic pole units 34. The positioning members 36 are made of non-magnetic material such as resin. Each of the permanent magnets 35 is magnetized in the radial direction of the brake magnetic pole units 34.

The positioning members 36 have formed in outer circumferential surfaces thereof stopper grooves 36a which hold the friction plate 30 from rotating in the circumferential direction. The friction plate 30 has a plurality of tabs 30a formed on an outer circumference thereof. Each of the tabs 30a is bent from the friction plate 30 and extends in the axial direction of the friction plate 30. Each of the tabs 30a engages one of the stopper grooves 36a, thereby stopping the friction plate 30 from rotating in the circumferential direction.

Each of the brake magnetic pole units 34 includes an outer magnetic pole strip 34a and an inner magnetic pole strip 34b. The outer magnetic pole strip 34a is attracted to an outer magnetic poles (e.g., an N-pole) of a corresponding one of the permanent magnets 35 and fixed outside the permanent magnet 35 in the radial direction of the brake magnetic pole units 34. The inner magnetic pole strip 34b is attracted by an inner magnetic pole (e.g., an S-pole) of a corresponding one of the permanent magnets 35 and fixed inside the permanent magnet 35 in the radial direction. Each of the outer magnetic pole strip 34a and the inner magnetic pole strip 34b of the brake magnetic pole units 34 has a width, that is, a dimension in the axial direction thereof which is greater than that of the permanent magnets 35. In other words, the outer magnetic pole strip 34a and the inner magnetic pole strip 34b have side portions which extend from the end of the permanent magnet 35 in the opposite motor direction (i.e., away from the motor 2) and are bent inwardly in the opposite directions so as to face each other through an air gap (i.e., a slit). The side portions of the outer magnetic pole strip 34a and the inner magnetic pole strip 34b which face each other in the radial direction of the brake magnetic pole units 34 will also be referred to below as magnetic pole teeth.

Each of the brake release coils 31 is, as illustrated in FIG. 3, made of wire wound around the resinous bobbin 37 and the magnetic pole teeth. Each of the brake magnetic pole units 34 and a corresponding one of the brake release coils 31 are electrically isolated from each other through, for example, insulating sheet. When exited, the brake release coils 31 produce magnetic fields which are oriented to act on the brake magnetic pole units 34 to cancel magnetic fields created by the permanent magnets 35.

The bobbins 37 are formed integrally with the annular coil holder 38. Each of the bobbins 37 surrounds the magnetic pole teeth in three different directions (i.e., two opposite circumferential directions and the motor direction (a direction closer to the motor 2).

The positioning members 36 are secured to the coil holder 38 using, for example, adhesive material so as to fix circumferential positions of the permanent magnets 35 in coincidence with the brake magnetic pole units 34.

The coil holder 38 is made up of the ring-shaped inner frame 38a, the polygonal (i.e., octagonal in this embodiment) outer frame 38b, and a plurality of ribs 38c. The inner frame 38a has an inner diameter which is greater by a few millimeters than an outer diameter of the internal gear 15. The outer frame 38b surrounds the outer circumference of the inner frame 38a. The ribs 38c connect the inner frame 38a and the outer frame 38b together to reinforce them. The bobbins 37 are located on flat sections of the outer circumferential surface of the outer frame 38b. The coil holder 38 is hold from rotating by press-fitting arc-shaped outer circumferences of the bobbins 37 into an inner circumference of the center case 39.

The center case 39 is, as illustrated in FIG. 1, disposed between the starter housing 26 and the yoke 8 and has an outer periphery on opposite motor side which is fixedly connected to an inner periphery of the starter housing 26 through a spigot joint. The center case 39 also has an inner periphery on the motor side which is fixedly connected to an inner periphery of the yoke 8 through a spigot joint. The center case 39, as illustrated in FIG. 3, also has the plate wall 39a which extends inwardly from an inner periphery on the opposite motor side perpendicular to the axial direction thereof. The partition wall 39a is formed integrally with the center case 39. The bearing (i.e., a shaft bush) 40 is fit on an inner circumference of the plate wall 39a.

The pinion thrust mechanism, as illustrated in FIG. 4, includes the cam cylinder 42, a fixing member (which will be described later in detail), the thrust collar 44, and the engaging pins 45. The cam cylinder 42 has the cam grooves 41 formed therein. The fixing member has formed therein the straight grooves 43 traversing the cam grooves 41 in the axial direction. The thrust collar 44 works as a transmission member and is fit on the pinion 5. The engaging pins 45 are retained by the thrust collar 44 and fit in the cam grooves 41 and the straight grooves 43.

The cam cylinder 42 has the hollow cylindrical portion 42a which extends over the outer circumference of the pinion 5 in the axial direction thereof. The cylindrical portion 42a is retained to be rotatable by a cylindrical inner peripheral surface formed on a portion of an inner wall of the starter housing 26. The cam grooves 41 are formed in two portions of the cylindrical portion 42a and diametrically opposed to each other in the radial direction of the cylindrical portion 42a, that is, symmetrically about the center of the cylindrical portion 42a. Each of the cam grooves 41 has a given length with a starting end (also called a first end) closer to the motor 2 and a terminal end (also called a second end) farther away from the motor 2. The starting ends of the cam grooves 41 are located at positions different from each other in the circumferential direction of the cylindrical portion 42a. Similarly, the terminal ends of the cam grooves 41 are located at positions different from each other in the circumferential direction of the cylindrical portion 42a. Each of the cam grooves 41 extends in a spiral form from the starting end to the terminal end in the circumferential direction of the cylindrical portion 42a.

The cam cylinder 42 has an end wall formed on the motor side thereof which defines the cylinder bottom 42b extending perpendicular to the length of the output shaft 3. The cylinder bottom 42b is formed integrally with the cylindrical portion 42a. The cylinder bottom 42b has a circular opening which is formed in a radial center portion thereof and has a plurality of protrusions 42c formed on an inner circumference thereof. The protrusions 42c are arranged at regular or equal intervals away from each other on the whole of the inner circumference of the cylinder bottom 42b. The cam cylinder 42 is joined to the internal gear 15 through the engaging plate 46 (which will be described later in detail) to be rotatable along with the internal gear 15 and the engaging plate 46. The engaging plate 46 includes the large-diameter cylinder, 46a and the small-diameter cylinder 46b. The large-diameter cylinder 46a is fit on the outer circumference of the cylindrical wall 20 of the internal gear 15. The small-diameter cylinder 46b is inserted into the circular opening of the cylinder bottom 42b and locked in tight engagement with the cylinder bottom 42b. The small-diameter cylinder 46b has an outer circumference which is retained to be rotatable by the center case 39 through the bearing 40.

The large-diameter cylinder 46a, as illustrated in FIG. 4, has a plurality of positioning grooves 46c from in the circumference thereof. The positioning protrusions 20a of the cylindrical wall 20 are fit in the positioning grooves 46c to hold the internal gear 15 and the engaging plate 46 from rotating relative to each other. The small-diameter cylinder 46b has a plurality of recesses 46d formed in a portion of the outer peripheral surface thereof which is located farther away from the motor 2 than the bearing 40 (see FIG. 3) is. The recesses 46d are arranged at equal intervals over the whole of the circumference of the small-diameter cylinder 46b. The protrusions 43c of the cylinder bottom 42b are fit in the recesses 46d to hold the engaging plate 46 and the cam cylinder 42 from rotating relative to each other. The small-diameter cylinder 46b has the circumferential groove 46e formed in a portion of the circumference thereof on the opposite motor side. The circumferential groove 46a extends over the whole of the circumference of the small-diameter portion 46b. A snap ring (see FIG. 1) is fit in the circumferential groove 46e to lock or stop the cam cylinder 42 from being removed from the small-diameter cylinder 46b. The small-diameter cylinder 46b has mounted on an inner circumference thereof the bearing 47 which works to retain the large-diameter portion (i.e., the inner 23) of the output shaft 3 and the outer periphery of the helical spline 28 to be rotatable.

The fixing member in the first embodiment is implemented by the starter housing 26 and, as illustrated in FIG. 4, has the straight grooves 43 formed in two portions of the inner circumference of the starter housing 26 which are diametrically opposed to each other. The starter housing 26 is fixed or held from moving in the axial and circumferential directions of the starter housing 26 (i.e., the cam cylinder 42). The straight grooves 43 each have an open end on the motor side and a closed end on the opposite motor side. The thrust collar 44 is, as can be seen in FIG. 1, located on an end portion of the pinion 5 which is closer to the motor 2 than the teeth 5b is. The thrust collar 44 is mounted on the pinion 5 to be rotatable relative to the pinion 5 and is held from moving in the axial direction of the pinion 5. The thrust collar 44 is inserted into the inner periphery of the cylindrical portion 42a and arranged to be rotatable relative to the cylindrical portion 42a and slidable in the axial direction of the cylindrical portion 42a. The thrust collar 44 has pin insertion holes 44a formed in two portions thereof which are diametrically opposed to each other (i.e., symmetrically about the center of the thrust collar 44).

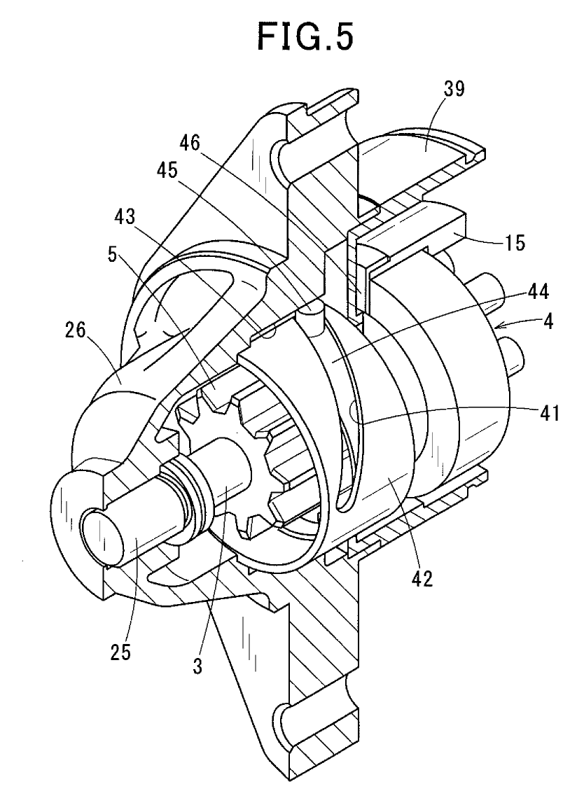

Each of the engaging pins 45 has an end portion fit in one of the pin insertion holes 44a and the other end portion which protrudes outside the pin insertion hole 44a in the radial direction and, as illustrated in FIG. 5, engages one of the cam grooves 41 and one of the straight grooves 43.

The operation of the starter 1 will be described below.

When the brake release coils 31 is deenergized or in an off-state, the brake plate 29 is attracted to the brake magnetic pole units 34 which is magnetized by the permanent magnets 35, so that it contacts the friction plate 30 to develop mechanical friction between the brake plate 29 and the friction plate 30, thereby braking the rotation of the brake plate 29. The brake plate 29 is held from rotating relative to the planetary carrier 17. Accordingly, when the brake plate 29 is locked from rotating, it will cause the planetary carrier 17 to be also locked from rotating. When the motor 2 is excited by the inverter when the planetary carrier 17 is locked from rotating, the torque of the motor shaft 9 is transmitted from the sun gear 14 to the planetary gears 16, so that the planetary gears 16 rotate about the planetary gear pins 18. This causes the internal gear 15 to rotate in a direction opposite the direction in which the sun gear 14 rotates, so that the rotation of the internal gear 15 is transmitted to the cam cylinder 42 through the engaging plate 46.

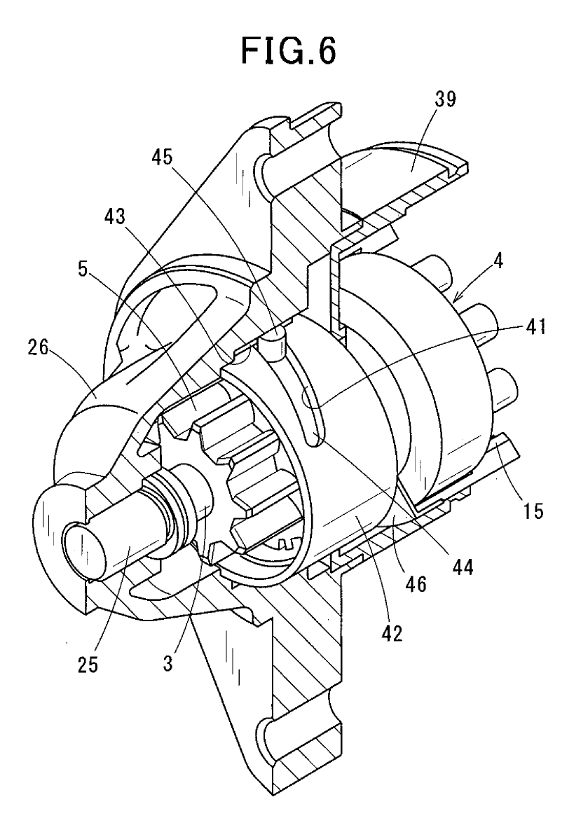

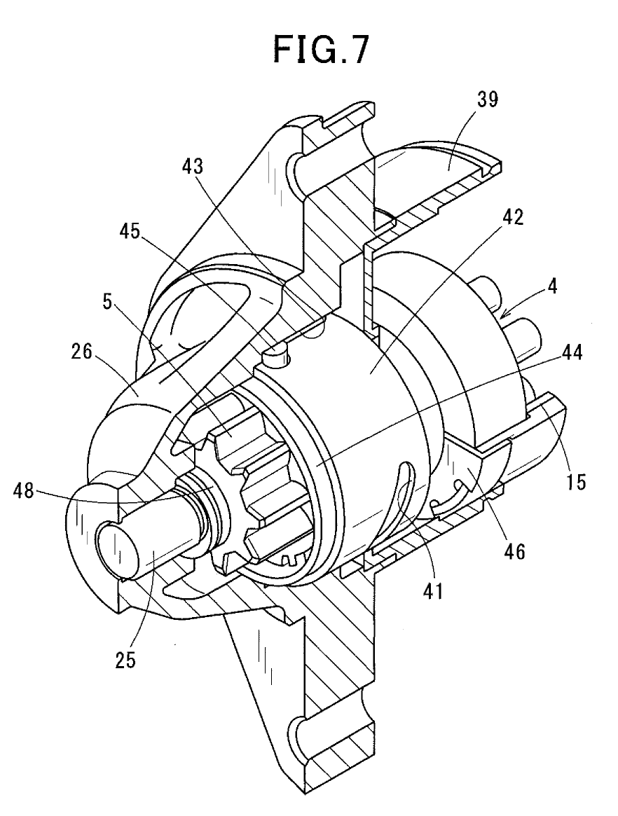

The rotation of the cam cylinder 42 in the direction opposite the rotation of the motor 2 will cause the force of thrust to be exerted in a direction away from the motor 2 on the engaging pins 45 which are positioned at locations where the straight grooves 43 intersect with the cam grooves 41, so that the engaging pins 45 are, as illustrated in FIGS. 5 to 7, moved in the cam grooves 41 with rotation of the cam cylinder 42 and also advanced away from the motor 2 in the straight grooves 43. The force of thrust acting on the engaging pins 45 is a force (which will also be referred to as a thrust force below) to push the pinion 5 in the axial direction thereof through the thrust collar 4, so that the pinion 5 travels away from the motor 2 while rotating about the output shaft 3 through the helical spline 28.

When the pinion 5 contacts the ring gear (not shown) of the engine and then stops moving in the opposite motor direction, it will cause the cam cylinder 42 to be stopped immediately from rotating, so that the internal gear 15 stops rotating. Subsequently, when the torque, as produced by the motor 2, exceeds a frictional torque developed between the brake plate 29 and the friction plate 30, the brake plate 29 and the friction plate 30 will slip relative to each other, so that planetary carrier 17 rotates.

The rotation of the planetary carrier 17 is transmitted to the output shaft 3 through the clutch 4, so that the pinion 5 rotates together with the output shaft 3 while contacting the ring gear. When the pinion 5 rotates until the teeth of the pinion 5 engage tooth grooves of the ring gear, in other words, the pinion 5 rotates to an angular position where the pinion 5 is engageable with the ring gear, the cam cylinder 42 is enabled to rotate again, so that the thrust force acts on the pinion 5 in the axial direction thereof, thereby causing the pinion 5 to advance further on the output shaft and then engages the ring gear. The pinion 5 meshing with the ring gear contacts the stopper 48, as illustrated in FIG. 1, mounted on the output shaft 3 and then is stopped from moving in the opposite motor direction.

When the pinion 5 contacts the stopper 48, so that it stops moving in the axial direction thereof, it will cause the cam cylinder 42 to be stopped from rotating. Specifically, when the pinion 5 engages the ring gear and contacts the stopper 48, it will cause the cam cylinder 42 is stopped from rotating further. When the cam cylinder 42 is stopped from rotating, the engaging pins 45 do not contact the closed end (i.e., terminal ends) of the cam grooves 41 and are located away from the closed end of the cam grooves 41 through a small air gap.

After the pinion 5 engages the ring gear, the brake release coils 31 is turned on or excited.

The magnetic field, as created by the brake release coils 31, acts on the brake magnetic pole units 34 to cancel the magnetic field developed by the permanent magnets 35. Specifically, the magnetic force, as produced by the permanent magnets 35 to attract the brake plate 29, is cancelled by the excitation of the brake release coils 31, so that the brake plate 29 is urged by the coil springs 33 away from the friction plate 30. This releases the rotation of the planetary carrier 17, so that the torque, as outputted by the motor 2, is amplified by the planetary gear train and then transmitted to the output shaft 3 through the clutch 4. This causes the pinion 5 to rotate together with the output shaft 3, thereby rotating the ring gear to crank the engine.

After the engine is cranked and then started up, the brake release coils 31 is deenergized. Simultaneously, the motor 2 is rotated by the inverter in a direction opposite the direction in which the motor 2 cranks the engine. The planetary carrier 17 is stopped from rotating together with the brake plate 29 upon the deenergization of the brake release coils 31, so that the cam cylinder 42 undergoes the reverse rotation of the motor 2 and rotates in a direction opposite a direction in which the cam cylinder 42 rotates when the engine is cranked. This reverse rotation of the cam cylinder 42 creates thrust acting on the engaging pins 45 in the motor direction. The thrust is then applied as a return force to the pinion 5 through the thrust collar 44, so that the pinion 5 is disengaged from the ring gear and moved back on the output shaft 3. The return force is a force which draws the pinion 5 in the axial direction thereof and acts in a direction opposite the thrust force.

After the pinion 5 is moved back on the output shaft 3 to a rest position (i.e. the position demonstrated in FIG. 1), the motor 2 is deenergized by the inverter.

### Operation and Beneficial Effect of the First Embodiment

The starter 1 of the first embodiment is engineered to have the planetary gear train working as a power split device which selectively establish a first power transmission system through which the torque, as produced by the motor 2, is transmitted to the planetary carrier 17 and a second power transmission system through which the torque, as produced by the motor 2, is transmitted to the internal gear 15. In other words, the planetary gear train (i.e., the power split device) works to split or distribute the torque, as inputted from the motor, to the first and second power transmission systems. The starter 1 also works to stop the planetary carrier 17 from rotating through the electromagnetic brake device to output the torque, as produced by the motor 2, from the internal gear 15. The rotation of the internal gear 15 transmitted to the cam cylinder 42 through the engaging plate 46 will cause the pinion thrust mechanism to convert rotating motion of the cam cylinder 42 into linear motion in the axial direction thereof which is transmitted to the pinion 5, so that the pinion 5 advances in the axial direction thereof.

1) The above structure eliminates the need for rotating the output shaft 3 when the pinion 5 is moved to the ring gear of the engine, that is, the need for thrusting the pinion 5 in the axial direction thereof with the aid of the operation of the helical spline 28 of the output shaft 3. In other words, the starter 1 is capable of moving the pinion 5 toward the ring gear without the use of the feed screw motion of the helical spline 28 and thus alleviates the need for the helical spline 28 on the output shaft 3, thereby enabling a straight spline to be employed instead of the helical spline 28.
2) The starter 1 of the first embodiment has no need for pressing the outer periphery of the pinion 5 to lock the pinion 5 from rotating when the pinion 5 slides on the output shaft 3, thus resulting in a decrease in loss of sliding motion of the pinion 5 as compared with the conventional starter, as taught in Japanese Patent First Publication No. 8-177691 discussed in the introductory part of this application, which will lead to a decrease in consumption of electrical energy in the motor 2.
3) The cam cylinder 42 is locked from rotating at a time when the pinion 5 meshes with the ring gear and then contacts the stopper 48, thus eliminating unnecessary rotation of the cam cylinder 42. The engaging pins 45 which move in the cam grooves 41 do not contact the closed ends of the cam grooves 41 at the time when the engaging plate 46 is stopped from rotating, in other words, they stop short of the closed ends of the cam grooves 41 through a small air gap, thus eliminating the risk that a load is undesirably exerted through the engaging pins 45 on the cam cylinder 42 in which the cam grooves 41 are formed. This enables the earn cylinder 42 to be shaped to have a decreased wall thickness and reduced in weight thereof.

Other embodiments of this disclosure will be described below. In the following discussion, the same reference numbers as employed in the first embodiment will refer to the same parts, and explanation thereof in detail will be omitted here.

### Second Embodiment

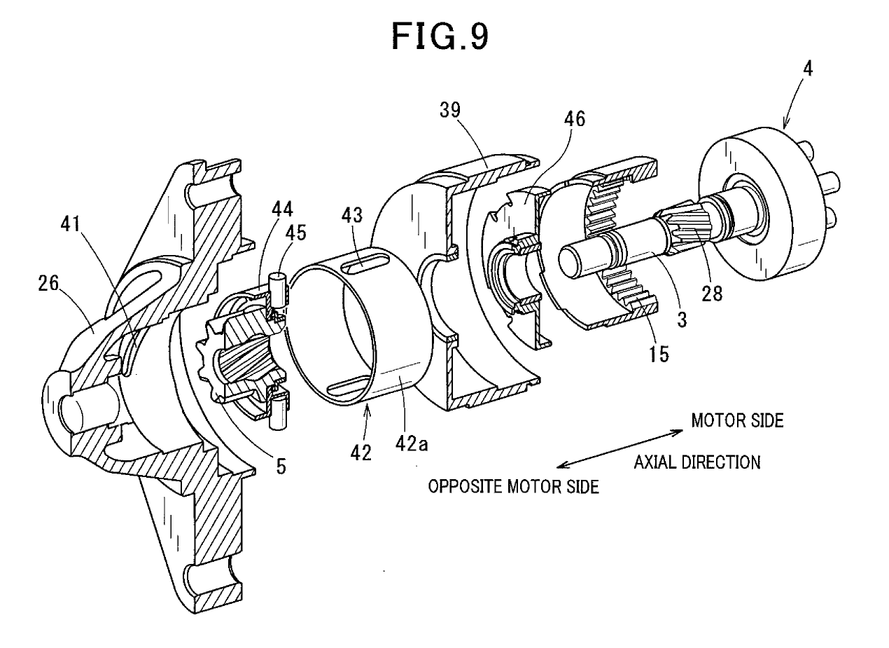

The second embodiment is, as illustrated in FIG. 9, an example where the cylindrical portion 42a of the cam cylinder 42 has the straight grooves 43 formed therein, and the starter housing 26 has the cam grooves 41 formed in the cylindrical inner periphery thereof. Each of the cam grooves 41 obliquely intersects with, that is, traverses one of the straight grove 43 at an angle other than zero and ninety degrees.

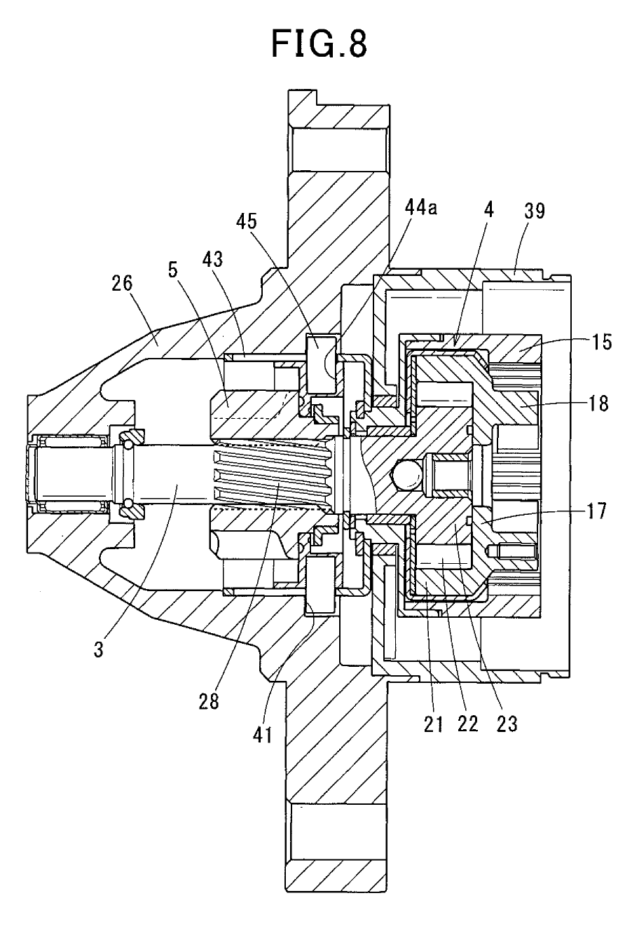

The engaging pins 45 are, like in the first embodiment, inserted at ends thereof into the pin insertion holes 44a of the thrust collar 44 (see FIG. 8), while the other ends of the engaging pins 45 engage the straight grooves 43 and the cam grooves 41.

The rotation of the cam cylinder 42 together with the internal gear 15 causes the engaging pins 45 which engage the straight grooves 43 and the cam grooves 41 to be moved along the cam grooves 41 in the opposite motor direction while being subjected to a rotating force. This axial motion of the engaging pins 45 is transmitted to the pinion 5 through the thrust collar 44, so that the pinion 5 is thrust on the output shaft 3 in the opposite motor direction to mesh with the ring gear of the engine.

The starter 1 of the second embodiment is, as described above, engineered to have the straight grooves 43 formed in the cylindrical portion 42a and the cam grooves 41 formed in the inner peripheral surface of the starter housing 26. Other arrangements are identical with those in the first embodiment, thus offering substantially the same beneficial effects as in the first embodiment.

### Third Embodiment

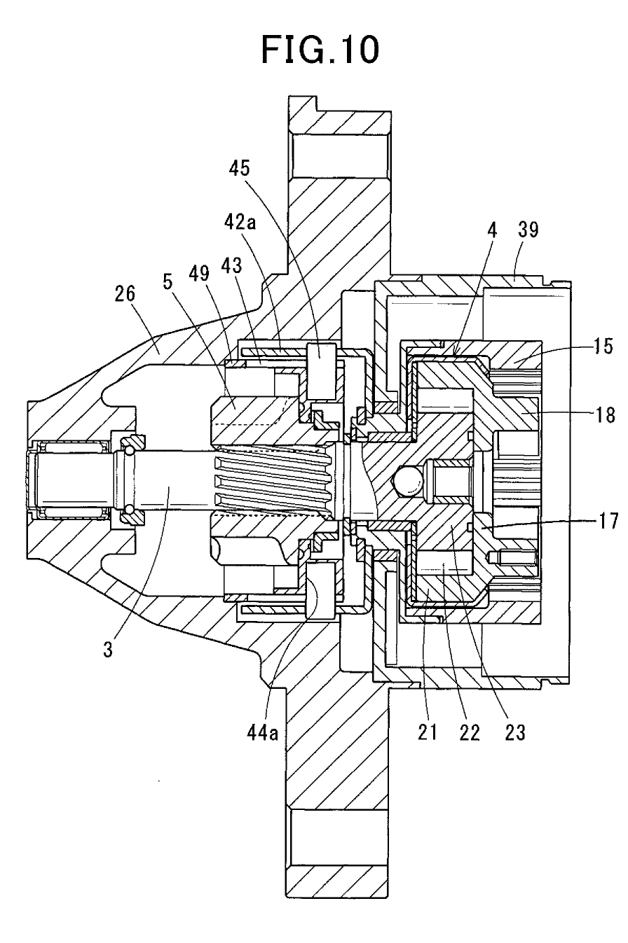

This embodiment is, as illustrated in FIG. 10, an example where the hollow cylinder 49 is disposed inside the inner periphery of the cylindrical portion 42a of the cam cylinder 42. The hollow cylinder 49 has the straight grooves 43 formed thereon and works as the fixing member, as described above.

The hollow cylinder 49 is partially press-fit in the inner wall of the starter housing 2, so that it is held from moving both in the axial direction and in the circumferential direction thereof.

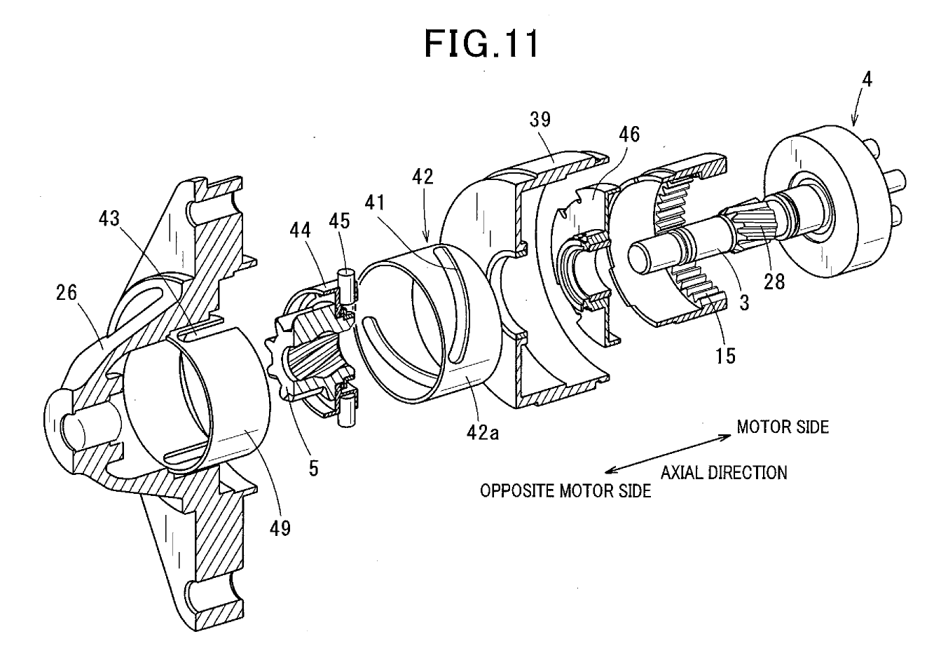

The cylindrical portion 42a of the cam cylinder 42, like in the first embodiment, has the cam grooves 41 formed therein (see FIG. 11). The engaging pins 45 which have ends fit in the pin insertion holes 44a of the thrust collar 44 have other ends which project outside the pin insertion holes 44a, extend through the straight grooves 43 in a thickness-wise direction of the hollow cylinder 49, and engage the cam grooves 41, respectively.

The starter 1 of the third embodiment is engineered to have the straight grooves 43 which are not formed in the starter housing 26, but in the hollow cylinder 49 and also have the hollow cylinder 49 which is disposed inside the inner circumference of the cylindrical portion 42a in which the cam grooves 41 are formed. Other arrangements are identical with those in the first embodiment, thus offering substantially the same beneficial effects as in the first embodiment.

### Fourth Embodiment

The starter 1 of this embodiment is different in structure of the electromagnetic brake device from the first embodiment and designed to hold the brake plate 29 from rotating using magnetic force produced by an electromagnet.

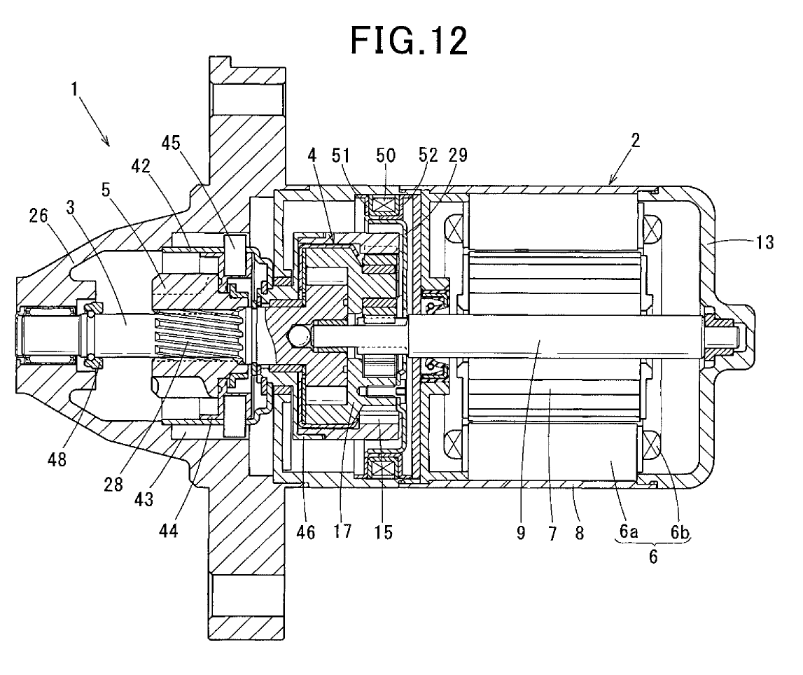

The electromagnetic brake device, as illustrated in FIG. 12, includes the brake coil 50 and a pair of magnetic pole cores 51 and 52. The brake coil 50 produces a magnetic field when energized. The magnetic pole cores 51 and 52 are disposed on opposite sides of the brake coil 50 in the axial direction thereof.

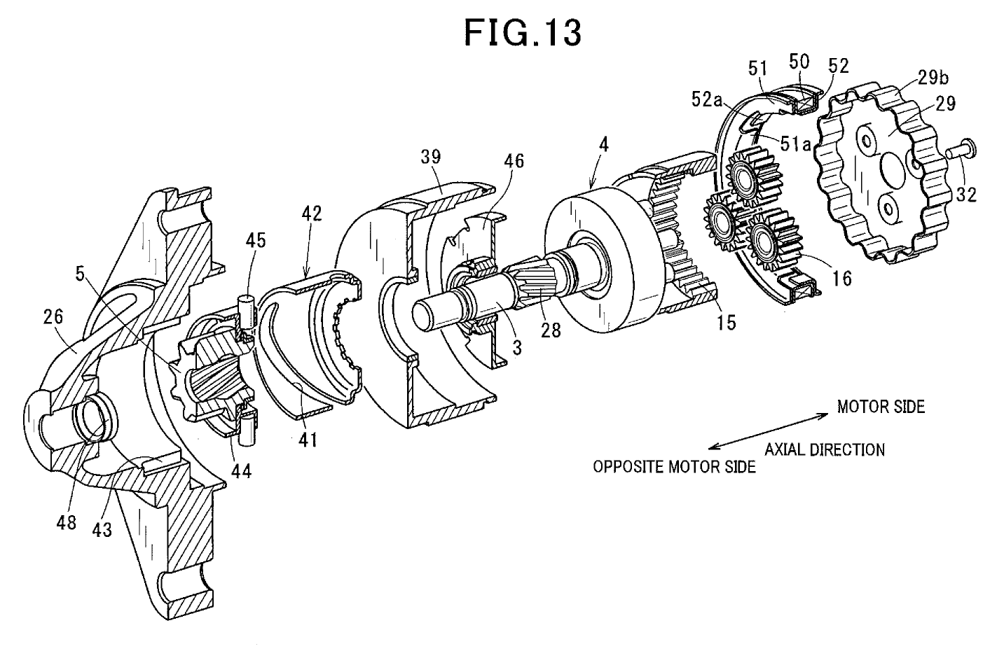

The magnetic pole core 51 is magnetized to have the S-pole upon energization of the brake coil 50, while the magnetic pole core 52 is magnetized to have the N-pole upon energization of the brake coil 50. The magnetic pole cores 51 and 52, as illustrated in FIG. 13, have magnetic claws (i.e., tabs) 51a and 52a, respectively. The magnetic claws 51a and 52a are arranged in a circumferential direction of the brake coil 50. The magnetic claws 51a are arranged at equal intervals away from each other. Similarly, the magnetic claws 52a are arranged at equal intervals away from each other. Each of the magnetic claws 51a engages one of the magnetic claws 52a inside the inner circumference of the brake coil 50. In other words, the magnetic pole claws 51a which are magnetized to have the S-pole and the magnetic pole claws 52a which are magnetized to have the N-pole are arranged alternately in the circumferential direction of the brake coil 50.

The brake plate 29, as illustrated in FIG. 13, includes a waved ring 29b which has a corrugated circumference defined by troughs and crests arranged successively and alternately. The waved ring 29b is disposed inside the inner circumference of the brake coil 50 and locked from rotating by holding torque developed between the wave ring 29b and the magnetic pole claws 51a and 52a which are magnetized. Specifically, the electromagnetic brake device of the fourth embodiment works to excite the brake coil 50 to hold the brake plate 29 from rotating.

When the motor 2 is energized when the brake plate 29 is locked from rotating, that is, the planetary carrier 17 is held from rotating (see FIG. 12), it causes, like in the first embodiment, the pinion 5 to be thrust on the output shaft 3 in the opposite motor direction with the aid of the operation of the pinion thrust mechanism and then mesh with the ring gear of the engine.

When the brake coil 50 is deenergized after the pinion 5 meshes with the ring gear of the engine, the rotation of the brake plate 29 is released to permit the planetary carrier 17 to rotate. This causes the torque, as produced by the motor 2, to be transmitted to the pinion 5 to rotate the ring gear of the engine.

In the fourth embodiment, the planetary carrier 17 is locked from rotating by the electromagnetic brake device, so that the internal gear 15 rotates in a direction opposite a direction in which the sun gear 14 rotates. The rotation of the internal gear 15 is then transmitted to the cam cylinder 42 through the engaging plate 46. The rotational motion of the cam cylinder 42 is converted by the pinion thrust mechanism into linear motion of the pinion 5. This thrusts the pinion 5 toward the ring gear of the engine without the use of the feed screw motion of the helical spline 28 on the output shaft 3, thus offering substantially the same beneficial effects as in the first embodiment.

### Fifth Embodiment

The starter 1 of the fifth embodiment uses the DC commutator motor 2 and includes an electromagnetic brake device which operates upon excitation or deexcitation of an electromagnet, and an electromagnetic clutch.

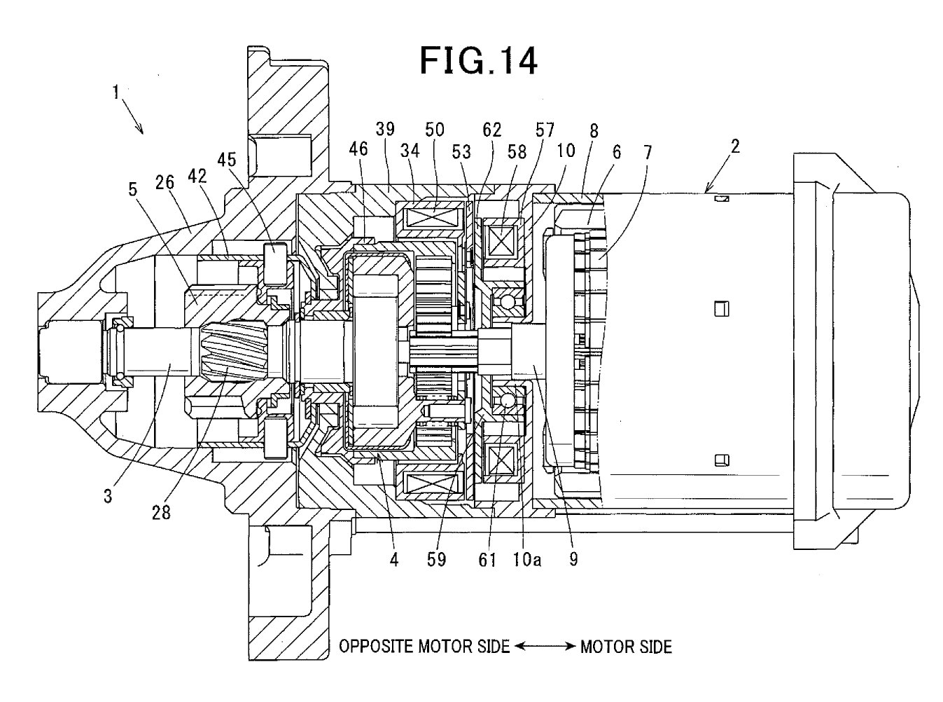

The motor 2 is a DC commutator motor which, as illustrated in FIG. 14, includes the stator 6 working as a field stator, the rotor 7 working as an armature, a commutator (not shown) disposed on an end of the motor shaft 9, and brushes (not shown) riding on the outer circumference of the commutator.

The field stator is made up of a plurality of permanent magnets arranged on the inner circumference of the yoke 8. Instead of the permanent magnets, a field electromagnet using a field coil may be employed. The armature includes an armature core and an armature coil. The armature core is made of a stack of a plurality of thin ferromagnetic plates and fit on the outer circumference of the motor shaft 9. The armature coil is wound around the armature core through slots formed in the armature core. The armature coil is connected to commutator segments which constitute the commutator.

The electromagnetic brake device and the electromagnetic clutch share the brake and clutch plate 53 with each other. The brake and clutch plate 53 is made of a ferromagnetic material such as iron

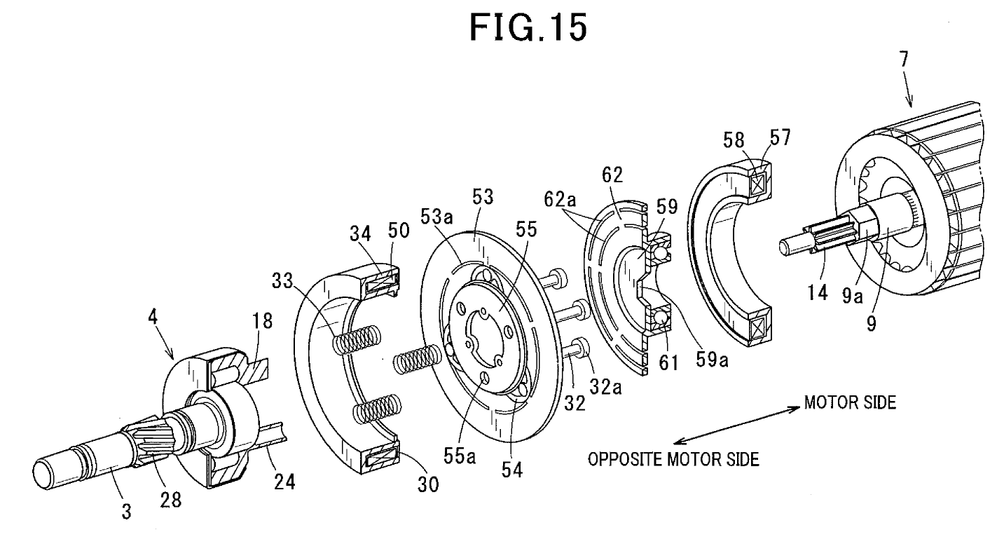

The brake and clutch plate 53 is, as illustrated in FIG. 15, joined to the non-magnetic base plate 55 through annular plate springs 54. The plate springs 54 is capable of being flexed or deformed relative to the base plate 55 to move the brake and clutch plate 53 in the axial direction thereof. The brake and clutch plate 53 has formed therein the magnetic shield grooves 53a which block magnetic currents. The magnetic shield grooves 53a pass through a thickness of the brake and clutch plate 53 and are arranged in a circle in a non-continuous way at intervals away from each other in a circumferential direction of the brake and clutch plate 53. The plate springs 54 are jointed at outer circumferential edges thereof to the brake and clutch plate 53 using, for example, rivets, and at inner circumferential edges thereof to the base plate 55 using, for example, rivets.

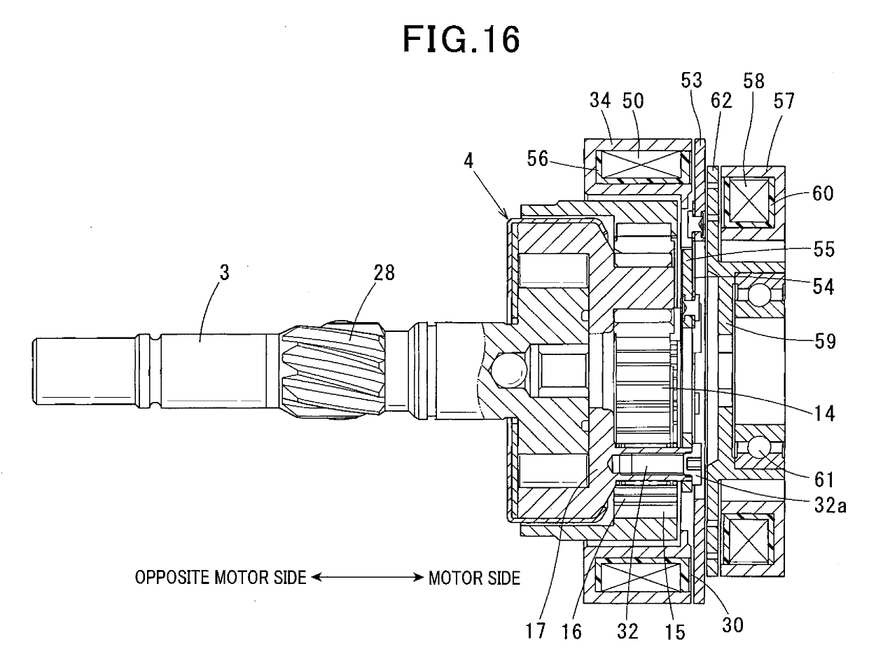

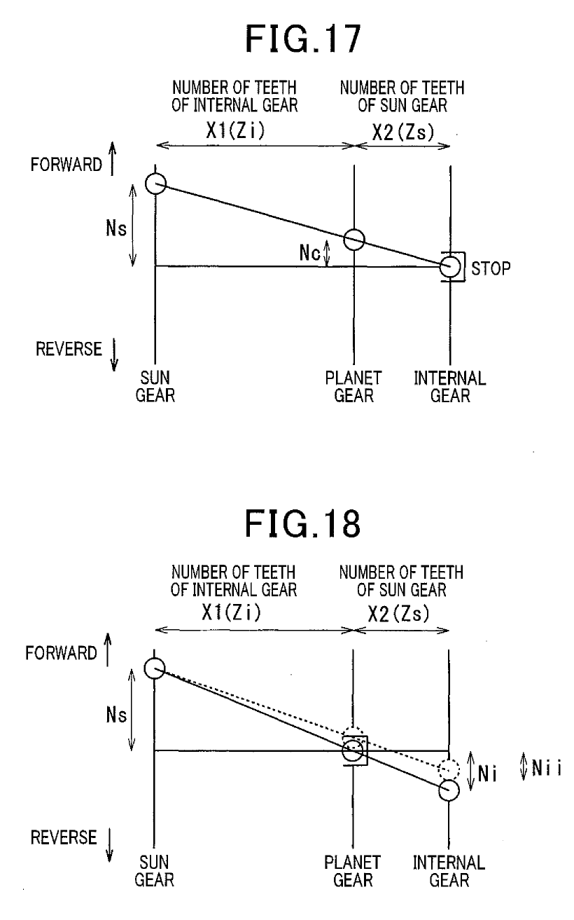

The base plate 55 has formed therein three circular holes 55a which pass through a thickness thereof. The circular holes 55a are arranged at intervals away from each other in a circumferential direction of the base plate 55. Each of the dummy pins 24 is fit in a respective one of the circular holes 55a and retained by the planetary carrier 17 (see FIG. 16) through engagement of the threaded hole of the dummy pin 24 and the bolt 32. The base plate 55 is slightly movable in the axial direction thereof and elastically urged in the motor direction by the coil springs 33 fit on the circumferences of the dummy pins 24. The base plate 55 is stopped from axially moving in the motor direction, as can be seen in FIG. 16, when the surface of the base plate 55 facing the motor 2 contacts the reverse surfaces of the bolt heads 32a and in the opposite motor direction when the brake and clutch plate 53 contacts the friction plate 30.

The electromagnetic brake device, as illustrated in FIG. 14, includes the single brake magnetic pole unit 34, the brake coil 50, and the friction plate 30. The brake magnetic pole unit 34 is disposed farther away from the motor 2 than the brake and clutch plate 53 is and secured to the center case 39. When energized, the brake coil 50 produces a magnetic field to magnetize the brake magnetic pole unit 34. The friction plate 30 is disposed on the motor side of the brake magnetic pole unit 34.

The brake magnetic pole unit 34, as illustrated in FIG. 16, forms a magnetic path which has a rectangular transverse cross section with four sides: one which opens in the motor direction, one which faces radially inwardly and is closed, one which faces radially outwardly and is closed, and one which faces away from the motor 2 and is closed.

The brake coil 50 is wound around the bobbin 56 and mounted in an inner chamber of the brake magnetic pole unit 34. The friction plate 30 is secured to, for example, the brake magnetic pole unit 34 and arranged at a small interval away from the brake and clutch plate 53. The distance by which the base plate 55 is movable in the axial direction thereof is slightly greater than an interval between the friction plate 30 and the brake and clutch plate 53.

The electromagnetic clutch, as illustrated in FIG. 14, includes the clutch magnetic pole unit 57, the clutch coil 58, and the rotating motor plate 59. The clutch magnetic pole unit 57 is arranged closer to the motor 2 than the brake and clutch plate 53 is and secured to the motor partition wall 10. When energized, the clutch coil 58 produces a magnetic field to magnetize the clutch magnetic pole unit 57. The rotating motor plate 59 is made of ferromagnetic material such as iron and rotatable together with the motor shaft 9.

The clutch magnetic pole unit 57 is, as can be seen in FIG. 16, made of an annular strip and forms a magnetic path which has a rectangular traverse cross section with four sides: one which opens in the opposite motor direction, one which faces radially inwardly and is closed, one which faces radially outwardly and is closed, and one which faces in the motor direction and is closed.

The clutch coil 58 is wound around the bobbin 60 and mounted in an inner chamber of the clutch magnetic pole unit 57. The rotating motor plate 59 is, as illustrated in FIGS. 14 and 15, retained to be rotatable through the ball bearing 61 fit on the outer circumference of the boss 10a of the motor partition wall 10. The rotating motor plate 59 has formed in a radially center portion thereof the non-circular hole 59a into which the non-circular portion 9a of the motor shaft 9 is inserted to hold the rotating motor plate 59 from rotating relative to the motor shaft 9.

The non-circular hole 59a formed in the rotating motor plate 59 and the non-circular portion 9a of the motor shaft 9 may be formed to have a shape which locks the motor shaft 9 and the rotating motor plate 59 from rotating relative to each other. For instance, the non-circular hole 59a and the traverse section of the non-circular portion 9a may be polygonal or oval.

The rotating motor plate 59 has the rotating clutch magnetic pole unit 62 formed in a shape of a plate or disc integrally therewith. The rotating clutch magnetic pole unit 62 is disposed between the brake and clutch plate 53 and the clutch magnetic pole unit 57 at small intervals away from the brake and clutch plate 53 and the clutch magnetic pole unit 57, respectively. The rotating clutch magnetic pole unit 62 has formed therein two arrays of magnetic shield grooves 62a which block magnetic currents. One of the arrays of the magnetic shield grooves 62a is located outside the array of the magnetic shield grooves 53a of the brake and clutch plate 53 in the radial direction of the rotating clutch magnetic pole unit 62, while the other array of the magnetic shield grooves 62a is located inside the array of the magnetic shield grooves 53a of the brake and clutch plate 53 in the radial direction of the rotating clutch magnetic pole unit 62. The magnetic shield grooves 62a, as can be seen in FIG. 15, pass through a thickness of the rotating clutch magnetic pole unit 62 and are arranged in two circles in a non-continuous way at intervals away from each other in the circumferential direction of the rotating clutch magnetic pole unit 62.

The operation of the starter 1 of the fifth embodiment will be described below.

The brake coil 50 and the motor 2 are excited in response to an engine start request.

When the brake magnetic pole unit 34 is magnetized upon the excitation of the brake coil 50, it attracts the brake and clutch plate 53 into contact with the friction plate 30. This causes a frictional force to be developed between the brake and clutch plate 53 and the friction plate 30, thereby locking the brake and clutch plate 53 from rotating to hold the base plate 55 which is joined to the brake and clutch plate 53 through the plate springs 54 from rotating. This also locks the planetary carrier 17 supporting the base plate 55 from rotating. When the planetary carrier 17 is locked from rotating, and the torque of the motor shaft 9 is transmitted from the sun gear 14 to the planetary gears 16, it will cause the planetary gears 16 to rotate around the planetary gear pins 18, so that the internal gear 15 rotates in a direction opposite the direction in which the sun gear 14 rotates.

The operation of the planetary gear train will be described below with reference to nomographs (also called alignment charts).

In the nomograph of FIG. 1, the left vertical axis represents the direction in which the sun gear 14 rotates and the rotating speed of the sun gear 14. The middle vertical axis represents the direction in which the planetary carrier 17 rotates and the rotating speed of the planetary carrier 17. The right vertical axis represents the direction in which the internal gear 15 rotates and the rotating speed of the internal gear 15. An intersection of the horizontal axis and each of the vertical axes indicates zero speed, that is, when a corresponding one of the sun gear 14, the planetary carrier 17, and the internal gear 15 is at rest. The upper side of the horizontal axis represents normal rotation, while the lower side of the horizontal axis represents reverse rotation. If an interval between the left vertical axis and the middle vertical axis, an interval between the middle vertical axis and the right vertical axis, the number of teeth of the internal gear 15, and the number of teeth of the sun gear 14 are defined as X1, X2, Zi, and Zs, respectively, a relation of X1:X2=Zi:Zs is met.

In a conventional starter equipped with a speed reducer implemented by a planetary gear train, as indicated by a solid line, when the internal gear 15 is held fixed, torque is inputted to the sun gear 14, reduced in speed to that of the planetary carrier 17, and then outputted. If the rotating speed of the sun gear 14 is defined as Ns, and the rotating speed of the planetary carrier 17 is defined as Nc, a speed reduction ratio is given by Eq. (1) below

Nc:Ns=Zs:(Zi+Zs) (1)

Thus, Nc=Ns×Zs/(Zi+Zs)

The nomograph in FIG. 18 shows that when the planetary carrier 17 is held from rotating, and the sun gear 14 is rotated, the internal gear 15 rotates in a direction opposite a direction in which the sun gear 14 rotates. When the planetary carrier 17 is held completely fixed, the internal gear 15, as indicated by a solid line, rotates at a speed Ni. However, when the planetary carrier 17 slips, it will cause, as indicated by a broken line, the internal gear 15 to rotate at a speed Nii (Ni>Nii) depending upon the degree of slippage of the planetary carrier 17. In this case, the rotating speed of the internal gear 15 is lower than that when the planetary carrier 17 is held fully fixed, but there is no problem with the planetary carrier 17 slipping without being held fully fixed because the internal gear 15 is required only to rotate in the reverse direction (i.e., a direction opposite the direction of rotation of the sun gear 14) for moving the pinion 5 to the ring gear of the engine.

The rotation of the internal gear 15 is transmitted to the cam cylinder 42 through the engaging plate 46. The rotation of the cam cylinder 42 causes the force of thrust to be exerted on the engaging pins 45 which moves the pinion 5 in the opposite motor direction.

After the pinion 5 contacts the ring gear of the engine, when slippage occurs between the brake and clutch plate 53 and the friction plate 30, so that the planetary carrier 17 rotates, the pinion 5 will rotate to an angular position where the teeth of the pinion 5 coincide with those of the ring gear of the engine and then mesh with the ring gear. The operation of the starter 1 in which, after the rotation of the internal gear 15 is transmitted to the cam cylinder 42 through the engaging plate 46, the pinion 5 is moved by the pinion thrust mechanism away from the motor 2 and then meshes with the ring gear of the engine is the same as that in the first embodiment.

When the brake coil 50 is deenergized after the ping gear 5 meshes with the ring gear of the engine, the brake and clutch plate 53 is disengaged from the friction plate 30, so that the force of frictional braking disappears therebetween, thus permitting the planetary carrier 17 to rotate. This causes torque, as produced by the motor 2, to be transmitted to the output shaft 3 through the clutch 4 without any loss of the torque caused by the force of frictional braking, so that the pinion 5 rotates together with the output shaft 3 to rotate the ring gear for cranking the engine.

Subsequently, after the engine is started, the clutch coil 58 is excited.

The magnetic field, as produced by the excitation of the clutch coil 58, works to magnetize the clutch magnetic pole unit 57 and also magnetize the rotating clutch magnetic pole unit 62 and the brake and clutch plate 53. This develops attraction between the rotating clutch magnetic pole unit 62 and the brake and clutch plate 53, so that the brake and clutch plate 53 is attracted to the rotating clutch magnetic pole unit 62 while being accompanied by elastic deformation of the plate springs 54.

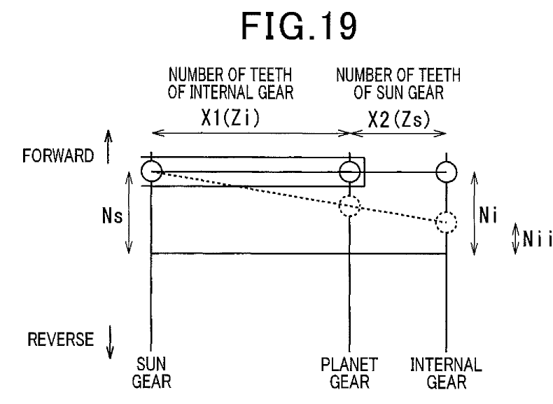

The rotating motor plate 59 equipped with the rotating clutch magnetic pole unit 62 engages and rotates together with the motor shaft 9, so that the brake and clutch plate 53 rotates in the same direction as that in which the motor shaft 9 rotates or follows the rotation of the motor shaft 9. The brake and clutch plate 53 is joined to the base plate 55 through the plate springs 54. The base plate 55 is held from rotating relative to the planetary carrier 17. This causes the planetary carrier 17 to follow the rotation of the motor shaft 9. When the motor shaft 9 and the planetary carrier 17 rotate together, the internal gear 15 will follow such rotation. The direction in which the internal gear 15 rotates is, as demonstrated in the nomograph of FIG. 19, the same as that in which the sun gear 14 and the planetary carrier 17 rotate, that is that in which the motor shaft 9 rotates.

When the rotation of the planetary carrier 17 is fully synchronized with that of the sun gear 14, the internal gear 15, as indicated by a solid line in FIG. 19, rotates at the speed Ni in the normal direction. The internal gear 15 is, however, required only to rotate in the normal direction for drawing the pinion 5 backward. Therefore, the planetary carrier 17 may, as indicated by a broken line, trail the sun gear 14 without having to rotate fully in synchronization with the sun gear 14 and rotate at the speed Nii (Ni Nii) in the normal direction.

The direction of rotation of the internal gear 15 is opposite the direction thereof when the pinion 5 is moved to the ring gear of the engine. The torque of the internal gear 15 is, therefore, converted into force drawing the pinion 5 backward away from the ring gear of the engine, that is, toward the motor 2, so that the pinion 5 is disengaged from the ring gear.

The starter 1 of the fifth embodiment is capable of attracting the brake and clutch plate 53 to the rotating clutch magnetic pole unit 62 through the electromagnetic clutch after the engine has been started up, thereby rotating the planetary carrier 17 in the same direction as that of the motor shaft 9. This causes the internal gear 15 to rotate in a direction opposite to that when the engine is cranked, thus eliminating the need for rotating the motor 2 in a direction opposite to that when cranking the engine when it is required to disengage the pinion 5 from the ring gear of the engine. In other words, the direction of rotation of the motor 2 remains unchanged when it is required to move the pinion 5 to the ring gear of the engine and when it is required to move the pinion 5 away from the ring gear of the engine. The motor 2, therefore, does not need to be changed in direction of rotation thereof and may be implemented by a DC commutator motor. Additionally, the starter 1 is capable of moving the pinion 5 in the axial direction thereof without the use of the feed screw motion of the helical spline 28 on the output shaft 3, thus offering substantially the same beneficial effects as in the first embodiment.

### Sixth Embodiment

The starter 1 of the sixth embodiment is, like in the fifth embodiment, designed to use the DC commutator motor 2 and have the electromagnetic brake device and the electromagnetic clutch, as discussed in the fifth embodiment, which are both engineered to be of a hysteresis type.

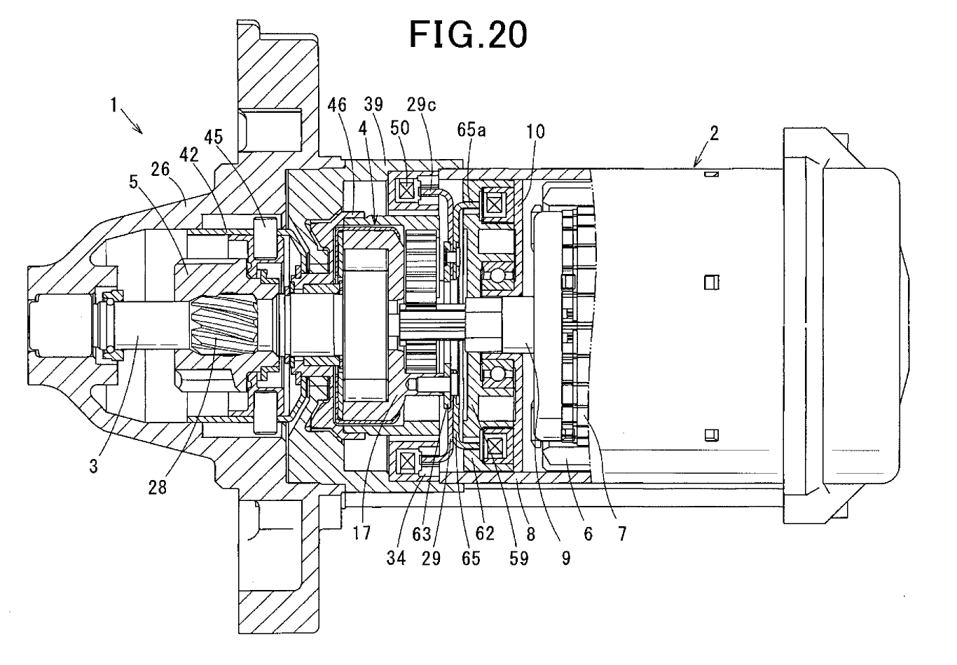

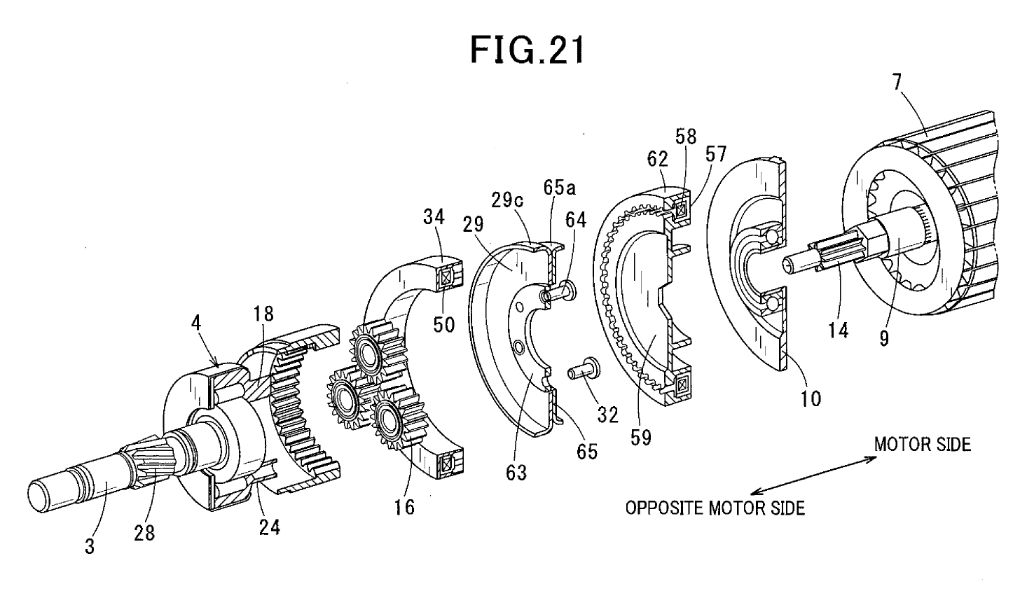

The structures of the hysteresis type of the electromagnetic brake device and the electromagnetic clutch will be described below with reference to FIGS. 20 and 21.

The electromagnetic brake device includes the brake plate 29, the magnetic pole unit 34, and the brake coil 50. The brake plate 29 is made of non-magnetic material and secured to the plate supporting disc 63 using vises 64. The brake magnetic pole unit 34 is secured to the center case 39. When excited, the brake coil 50 produces a magnetic field to magnetize the brake magnetic pole unit 34.

The plate supporting disc 63 is attached to the dummy pins 24 through, for example, the bolts 32 and held from rotating relative to the planetary carrier 17.

The brake plate 29 is made of, for example, ferrite material which is usually to make permanent magnets and has hysteresis characteristics. The brake plate 29 has a circumferential edge bent away from the motor 2 to define the brake cylindrical portion 29c.

The brake magnetic pole unit 34 is, as can be seen in FIG. 21, disposed to cover the brake cylindrical portion 29c in contactless fashion from outside and inside it in the radial direction of the brake magnetic pole unit 34. The brake magnetic pole unit 34 has two inner circumferential surfaces one of which will be referred to as an external inner circumferential surface and one of which will be referred to as an internal inner circumferential surface. The external and internal inner circumferential surfaces face each other in the radial direction of the brake magnetic pole unit 34. The brake magnetic pole unit 34 has a plurality of protrusions formed on the external and internal inner circumferential surfaces. The protrusions form magnetic poles and are arranged at a constant interval away from each other in the circumferential direction of the brake magnetic pole unit 34.

The brake coil 50 is wound around a bobbin and, as clearly illustrated in FIGS. 20 and 21, disposed in an inner chamber of the brake magnetic pole unit 34.

The electromagnetic clutch includes the clutch plate 65, the rotating clutch magnetic pole unit 62, the clutch magnetic pole unit 57, and the clutch coil 58. The clutch plate 65 is, as can be seen in FIG. 20, secured to the plate supporting disc 63 together with the brake plate 29 using the common vises 64. The rotating clutch magnetic pole unit 62 is formed in a shape of an annular strip assembly and arranged together with the rotating motor plate 59 as a disc. The clutch magnetic pole unit 57 is disposed on the motor side of the rotating clutch magnetic pole unit 62 and fixed on the motor partition wall 10. When excited, the clutch coil 65 produces a magnetic field to magnetize the clutch magnetic pole unit 57.

The clutch plate 65 is, like the brake plate 29, made of ferrite material and has magnetic hysteresis characteristics. The clutch plate 65 has a circumferential edge bent toward the motor 2 in the axial direction thereof to define the clutch cylindrical portion 65a.

The rotating clutch magnetic pole unit 62 is disposed to cover the clutch cylindrical portion 65a in contactless fashion from outside and inside it in the radial direction of the rotating clutch magnetic pole unit 62. The rotating clutch magnetic pole unit 62 has two inner circumferential surfaces one of which will be referred to as an external inner circumferential surface and one of which will be referred to as an internal inner circumferential surface. The external and internal inner circumferential surfaces face each other in the radial direction of the rotating clutch magnetic pole unit 62. The rotating clutch magnetic pole unit 62 has a plurality of protrusions formed on the external and internal inner circumferential surfaces. The protrusions form magnetic poles and are arranged at a constant interval away from each other in the circumferential direction of the rotating clutch magnetic pole unit 62.

The clutch magnetic pole unit 57 forms a magnetic path which has a rectangular traverse cross section with four sides: one which opens in the opposite motor direction, one which faces radially inwardly and is closed, one which faces radially outwardly and is closed, and one which faces toward the motor 2 and is closed.

The clutch coil 58 is wound around a bobbin and, as clearly illustrated in FIGS. 20 and 21, disposed in an inner chamber of the clutch magnetic pole unit 57. When the clutch coil 58 is excited, so that the clutch magnetic pole unit 57 is magnetized, it causes the rotating clutch magnetic pole unit 62 to be magnetized through the clutch magnetic pole unit 57.

The operation of the starter 1 of the sixth embodiment will be described below.

The brake coil 50 and the motor 2 are excited in response to an engine start request.

When the brake magnetic pole unit 34 is magnetized upon the excitation of the brake coil 50, magnetic fluxes flowing through inner and outer magnetic poles of the brake magnetic pole unit 34 pass through a thickness of the brake cylindrical portion 29c, so that a magnetic braking force is developed between each of the inner and outer magnetic poles and the brake cylindrical portion 29c, thereby holding the brake plate 29 from rotating. This locks the plate supporting disc 63 to which the brake plate 29 is joined from rotating to hold the planetary carrier 17 supporting the plate supporting disc 63 from rotating. When the planetary carrier 17 is locked from rotating, and the torque of the motor shaft 9 is transmitted from the sun gear 14 to the planetary gears 16, it will cause the planetary gears 16 to rotate around the planetary gear pins 18, so that the internal gear 15 rotates in a direction opposite the direction in which the sun gear 14 rotates. The operation of the starter 1 in which, after the rotation of the internal gear 15 is transmitted to the cam cylinder 42 through the engaging plate 46, the pinion 5 is moved by the pinion thrust mechanism away from the motor 2 and then meshes with the ring gear of the engine is the same as that in the first embodiment.

When the brake coil 50 is deenergized after the ping gear 5 meshes with the ring gear of the engine, the magnetic braking force acting on the brake plate 29 disappears, thus permitting the planetary carrier 17 to rotate along with the brake plate 29. This causes torque, as produced by the motor 2, to be transmitted to the output shaft 3 through the clutch 4, so that the pinion 5 rotates together with the output shaft 3 to rotate the ring gear for cranking the engine.

Subsequently, after the engine is started, the clutch coil 58 is excited.

When the rotating clutch magnetic pole unit 62 is magnetized by the clutch magnetic pole unit 57 upon the excitation of the clutch coil 58, magnetic fluxes flowing through inner and outer magnetic poles of the rotating clutch magnetic pole unit 62 pass through a thickness of the clutch cylindrical portion 65a, so that the clutch cylindrical portion 65a and the rotating clutch magnetic pole unit 62 are magnetically coupled with each other.

The rotating motor plate 59 integrally joined to the rotating clutch magnetic pole unit 62 rotate along with the motor shaft 9, so that the clutch plate 65 equipped with the clutch cylindrical portion 65a rotates in the same direction as that in which the motor shaft 9 rotates or follows the rotation of the motor shaft 9. The clutch plate 65 is held through the plate supporting disc 63 from rotating relative to the planetary carrier 17, so that the planetary carrier 17 follows the rotation of the motor shaft 9. When the motor shaft 9 and the planetary carrier 17 rotate together, it will cause the internal gear 15 to rotate. The direction of rotation of the internal gear 15 is opposite the direction thereof when the pinion 5 is moved toward the ring gear of the engine. The rotating motion of the cam cylinder 42 rotating along with the internal gear 15 is, therefore, converted into force drawing the pinion 5 backward away from the ring gear of the engine, that is, toward the motor 2, so that the pinion 5 is disengaged from the ring gear.

The starter 1 of the sixth embodiment is designed that, after the engine is started up, the electromagnetic clutch establishes a magnetic connection of the clutch plate 65 and the rotating motor plate 59 to rotate the planetary carrier 17 in the same direction as that in which the motor shaft 9 rotates. This causes the internal gear 15 to rotate in a direction opposite to that when the engine is cranked, thus eliminating the need for rotating the motor 2 in a direction opposite to that when cranking the engine when it is required to disengage the pinion 5 from the ring gear of the engine. In other words, the direction of rotation of the motor 2, like in the fifth embodiment, remains unchanged when it is required to move the pinion 5 to the ring gear of the engine and when it is required to move the pinion 5 away from the ring gear of the engine. The motor 2, therefore, does not need to be changed in direction of rotation thereof and may be implemented by a DC commutator motor. Additionally, the starter 1 is capable of moving the pinion 5 in the axial direction thereof without the use of the feed screw motion of the helical spline 28 on the output shaft 3, thus offering substantially the same beneficial effects as in the first embodiment.

### Seventh Embodiment

The starter 1 of the seventh embodiment, like in the fifth and sixth embodiments, uses the DC commutator motor 2 and has a power split device implemented by a differential gear unit.

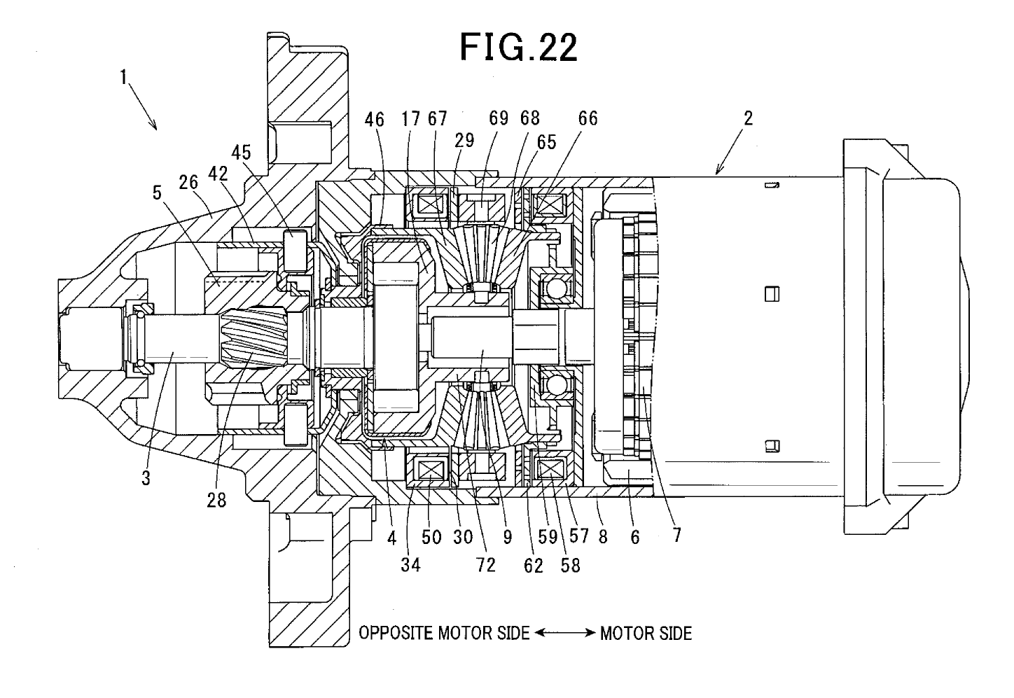

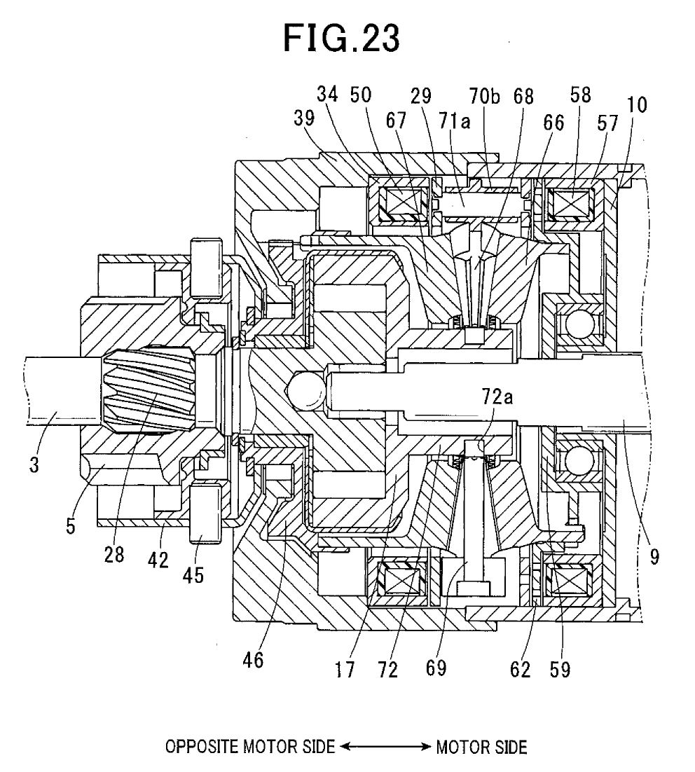

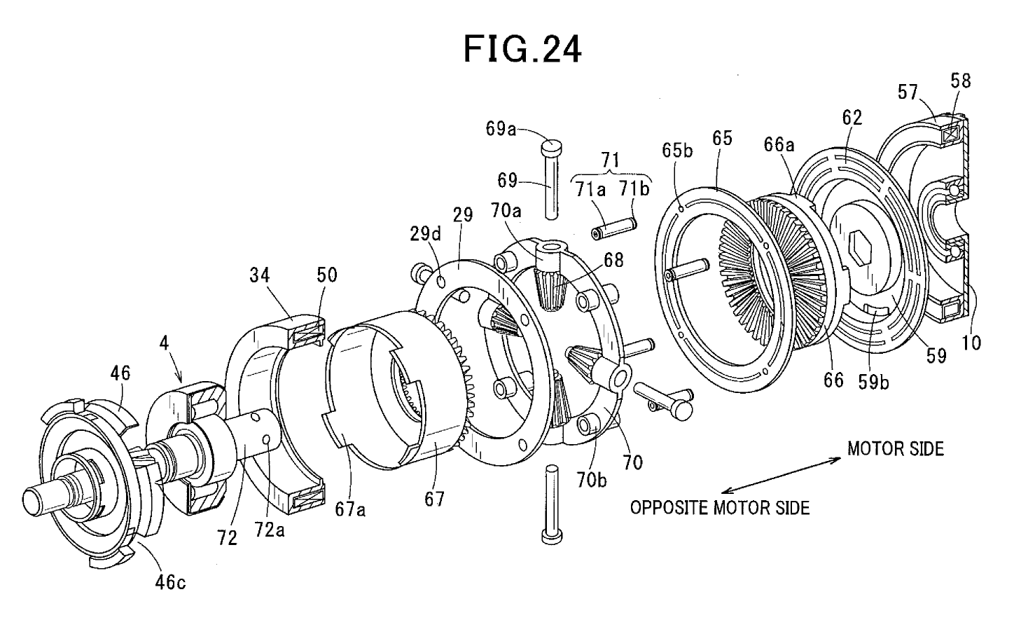

The differential gear unit, as illustrated in FIGS. 22 and 23, includes two large bevel gears 66 and 67, a plurality of small bevel gears 68, and the annular bevel gear holder 70 (see FIG. 24). The large bevel gears 66 and 67 are disposed coaxially with the motor shaft 9 and face each other in the axial direction thereof. The small bevel gears 68 mesh with the large bevel gears 66 and 67. The bevel gear holder 70 retains the small bevel gears 68 to be rotatable through the shafts 69. The bevel gear holder 70 will also be referred to as a first output of the power split device. The large bevel gear 67 will also be referred to as a second output of the power split device.

Each of the large bevel gears 66 and 67 has a tooth-bearing face on which teeth extend radially about the center of rotation thereof. The large bevel gear 66 works as a driving bevel gear, while the large bevel gear 67 works as a trailing bevel gear. The tooth-bearing faces of the large bevel gears 66 and 67 face each other in the axial direction thereof.

The large bevel gear 66 working as the driving bevel gear, as illustrated in FIG. 24, has a hollow cylindrical portion which extends from an outer periphery of the tooth-bearing face thereof toward the motor 2 in the axial direction of the large bevel gear 66 and on which a plurality of protrusions 66a formed. The protrusions 66a are fit in engaging grooves 59b formed in the rotating motor plate 59 to hold the large bevel gear 66 from rotating relative to the rotating motor plate 59.

The large bevel gear 67 working as the trailing bevel gear, as illustrated in FIG. 24, has a hollow cylindrical portion which extends from an outer periphery of the tooth-bearing face thereof away from the motor 2 in the axial direction of the large bevel gear 66 and on which a plurality of protrusions 67a formed. The protrusions 67a are fit in the positioning grooves 46c formed in the engaging plate 46 to hold the large bevel gear 67 from rotating relative to the engaging plate 46.

Each of the small bevel gears 68 rotates about a respective one of the shafts 69 and also orbits around the motor shaft 9 together with the bevel gear holder 70.

The bevel gear holder 70, as illustrated in FIG. 24, has four radially extending cylinders 70a with through-holes into which the shafts 69 are inserted and four axially extending cylinders 70b with through-holes into which the connecting pins 71, as will be described later in detail, are inserted. The radially extending cylinders 70a and the axially extending cylinders 70b are arranged alternately at equal intervals away from each other in a circumferential direction of the bevel gear holder 70.

Each of the shafts 69 has formed on an end thereof the shaft head 69a is press-fit in the through-hole of a corresponding one of the radially extending cylinders 70a. Each of the shafts 69 has an end which is opposite the shaft head 69a and extends radially inwardly from a corresponding one of the small bevel gears 68 is fit in one of the engaging holes 72a formed in the clutch barrel 72.

The clutch barrel 72 is a hollow cylinder which, as illustrated in FIG. 23, extends on the motor side of the planetary carrier 17 and has the four engaging holes 72a formed therein.

The connecting pins 71 are parts which mechanically connect between the brake plate 29 of the electromagnetic brake device and the clutch plate 65 of the electromagnetic clutch. Each of the connecting pins 71 has a length made up of two pin ends 71b and the pin body 71a extending between the pin ends 71b. The pin body 71a is inserted into one of the axially extending cylinders 70b.

The pin bodies 71a, as can be seen in FIG. 23, each have a length slightly longer than that of the axially extending cylinders 70b. Each of the pin bodies 71a is slidably fit in the through-hole of a corresponding one of the axially extending cylinders 70b. The pin ends 71b are cylindrical and have an outer diameter which is slightly smaller than an outer diameter of the pin bodies 71a.

The joint of the connecting pins 71 and the brake plate 29 is achieved by inserting one of the pin ends 71b of each of the connecting pins 71 into one of the small-diameter holes 29a, as illustrated in FIG. 24, formed in the brake plate 29 and then pressing it in the axial direction thereof so that it is plastically deformed outwardly in the radial direction thereof. Similarly, the joint of the connecting pins 71 and the clutch plate 65 is achieved by inserting the other one of the pin ends 71b of each of the connecting pins 71 into one of the small-diameter holes 65b, as illustrated in FIG. 24, formed in the clutch plate 65 and then pressing it in the axial direction thereof so that it is plastically deformed outwardly in the radial direction thereof.

The brake plate 29 and the clutch plate 65 have counterbores formed therein coaxially with the small-diameter holes 29d and the small-diameter holes 65b in order to prevent the plastically deformed pin ends 71b from extending outside the small-diameter holes 29d and 65b.

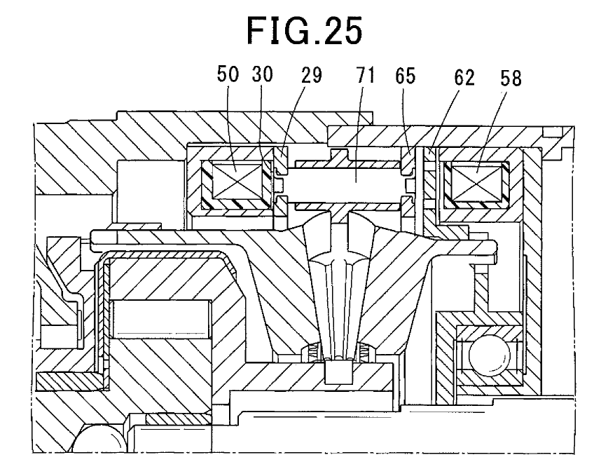

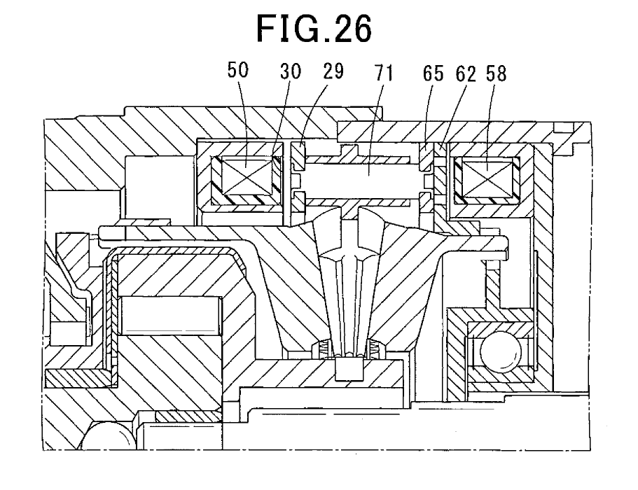

An assembly of the brake plate 29 and the clutch plate 65 which are joined together by the connecting pins 71 is movable in the axial direction between the first position, as illustrated in FIG. 25, where the brake plate 29 contacts the friction plate 30 and the second position, as illustrated in FIG. 26, where the clutch plate 65 contacts the rotating clutch magnetic pole unit 62. In other words, at the first position where the brake plate 29 contacts the friction plate 30, the clutch plate 65 is separate from the rotating clutch magnetic pole unit 62. At the second position where the clutch plate 65 contacts the rotating clutch magnetic pole unit 62, the brake plate 29 is separate from the friction plate 30.

The electromagnetic brake device and the electromagnetic clutch are substantially identical in structure and operation as those in the fifth embodiment except for the structure in which the brake plate 29a and the clutch plate 65 which work to perform the same function as that of the brake and clutch plate 53 in the fifth embodiment are discrete parts separate from each other.

The operation of the starter 1 of the seventh embodiment will be described below.

The brake coil 50 and the motor 2 are excited in response to an engine start request.

When the brake plate 29 is attracted to the brake magnetic pole unit 34 and then contacts the friction plate 30 upon the excitation of the brake coil 50, the force of friction, as developed between the brake plate 29 and the friction plate 30, locks the brake plate 29 from rotating. This causes the bevel gear holder 70 which retains the connecting pins 71 connecting the brake plate 29 and the clutch plate 65 to be locked from rotating, thereby stopping the small bevel gears 68 which are retained by the bevel gear holder 70 using the shafts 69 from orbiting around the motor shaft 9.

The rotation of the motor shaft 9 is transmitted to the large bevel gear 66 serving as the driving bevel gear through the rotating motor plate 59 and then transmitted to the small bevel gears 68 connecting with the large bevel gear 66. This causes the small bevel gears 68 to rotate about the shafts 69, respectively, so that the large bevel gear 67 working as the trailing bevel gear rotates in a direction opposite a direction in which the large bevel gear 66 serving as the driving bevel gear rotates.

The operation of the starter 1 in which, after the rotation of the large bevel gear 67 working as the trailing bevel gear is transmitted to the cam cylinder 42 through the engaging plate 46, the pinion 5 is thrust to the ring gear of the engine and then meshes with the ring gear with the aid of the operation of the pinion thrust mechanism is the same as that in the first embodiment.

When the brake coil 50 is deexcited after the pinion 5 meshes with the ring gear, the frictional braking force acting on the brake plate 29 disappears, thus permitting the brake plate 29 to rotate, so that the bevel gear holder 70 is also permitted to rotate. This causes the small bevel gears 68 to experience both the rotational motion and the orbital motion as a function of a difference in rotating speed between the large bevel gear 67 serving as the trailing bevel gear locked by the engaging plate 46 from rotating and the large bevel gear 66 serving as the driving bevel gear which is rotated by the torque transmitted from the motor shaft 9. The orbital motion is then transmitted to the clutch barrel 72 through the bevel gear holder 70, thus causing the torque of the motor 2 to be transmitted to the output shaft 3 through the clutch 4, which rotates the pinion 5 together with the output shaft 3, thereby rotating the ring gear to crank the engine.

After the engine is cranked and started up, the clutch coil 58 is excited.

The clutch plate 65 is attracted to the rotating clutch magnetic pole unit 62 which is magnetized upon the excitation of the clutch coil 58, so that the clutch plate 65 and the bevel gear holder 70 rotate or follow the rotation of the motor shaft 9 in the same direction as that of the motor shaft 9. This causes the large bevel gear 66 serving as the driving bevel gear which is joined to the motor shaft 9 through the rotating motor plate 59 to rotate together with the bevel gear holder 70, so that the large bevel gear 67 serving as the trailing bevel gear rotates. The direction of rotation of the large bevel gear 67 serving as the trailing bevel gear is the same as that of the large bevel gear 66 serving as the driving bevel gear and the bevel gear holder 70. In other words, the large bevel gear 66 serving as the driving bevel gear, the bevel gear holder 70, and the large bevel gear 67 serving as the trailing bevel gear rotate together in the same direction as that in which the motor shaft 9 rotates.

The direction of rotation of the large bevel gear 67 serving as the trailing bevel gear is opposite to that when the pinion 5 is thrust toward the ring gear of the engine. The rotation of the large bevel gear 67 is, therefore, converted into force drawing the pinion 5 backward away from the ring gear of the engine, that is, toward the motor 2, so that the pinion 5 is disengaged from the ring gear.

The starter 1 of the seventh embodiment does not need to rotate the motor 2 to disengage the pinion 5 from the ring gear in a direction opposite to that when cranking the engine. In other words, the direction of rotation of the motor 2 remains unchanged when it is required to move the pinion 5 to the ring gear of the engine and when it is required to move the pinion 5 away from the ring gear of the engine. The motor 2 may, therefore, be implemented, like in the fifth and sixth embodiment, by a DC commutator motor. Additionally, the starter 1 is capable of moving the pinion 5 in the axial direction thereof without the use of the feed screw motion of the helical spline 28 on the output shaft 3, thus offering substantially the same beneficial effects as in the first embodiment.

The electromagnetic brake device and the electromagnetic clutch may be designed to be of a hysteresis type, as described in the sixth embodiment.

### Eighth Embodiment

The starter 1 of the eighth embodiment is equipped with a non-contact type of electromagnetic brake device and a rotation stopper mechanism which stops the internal gear 15 from rotating when the engine is cranked.

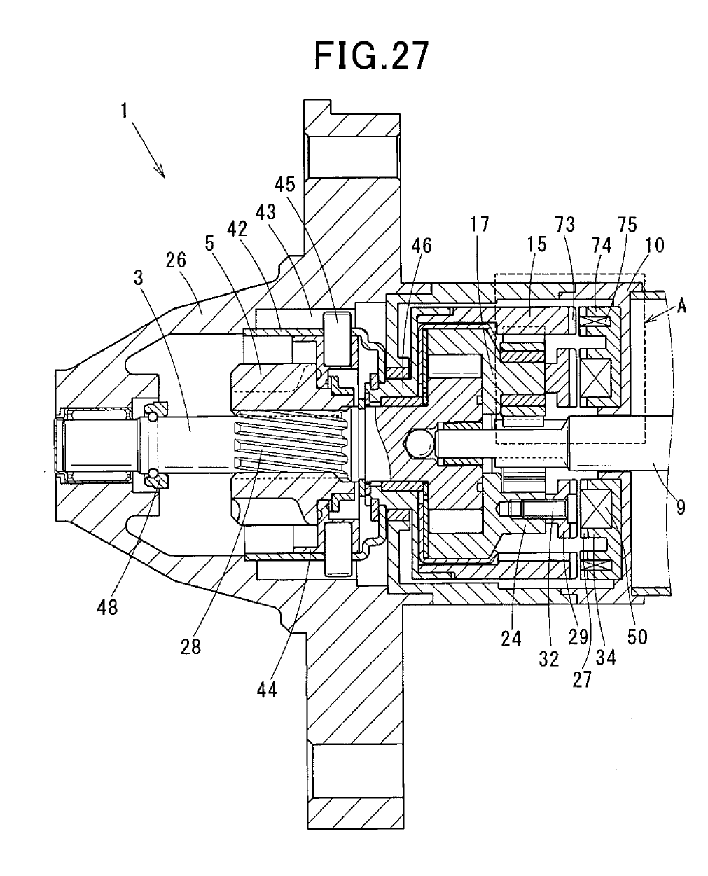

The electromagnetic brake device, as illustrated in FIG. 27, includes the ring shaped brake plate 29, the brake magnetic pole unit 34, and the brake coil 50. The brake plate 29 is secured to the dummy pins 24 of the planetary gear train through the bolts 32. The brake magnetic pole units 34 are placed in a non-contact fashion away from the brake plate 29. When excited, the brake coil 50 produces a magnetic field to magnetize the brake magnetic pole unit 34.

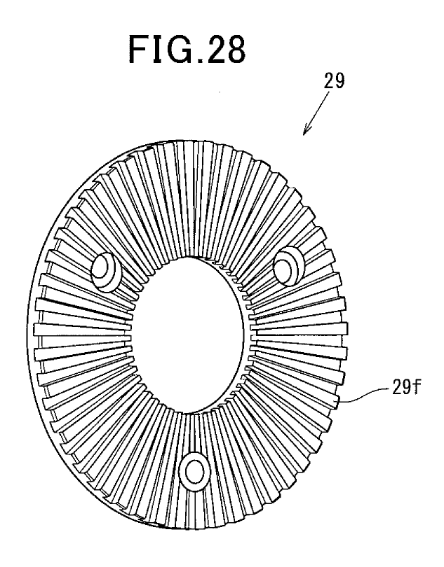

The brake plate 29, as illustrated in FIG. 28, has a plurality of protrusions or teeth 29f formed on an entire surface thereof which faces the brake magnetic pole unit 34. The teeth 29f extend radially and are arrayed successively at regular intervals in the circumferential direction of the surface of the brake plate 29. The brake magnetic pole unit 34 forms a magnetic path which has a rectangular traverse cross section with four sides: one (i.e., the left side, as viewed in FIG. 27) which opens in the opposite motor direction, one which faces radially inwardly and is closed, one which faces radially outwardly and is closed, and one (i.e., the right side, as viewed in FIG. 27) which faces the motor 2 and is closed. The brake magnetic pole unit 34, like the brake plate 29, has a plurality of protrusions or teeth 34f, as illustrated in FIG. 27, formed on an entire surface thereof which faces the brake plate 29. The teeth extend radially and are successively arrayed at regular intervals in the circumferential direction of the surface of the brake magnetic pole unit 34. The brake magnetic pole unit 34 is fixedly secured to, for example, the motor partition wall 10.

The brake coil 50 is wound around a bobbin (not shown) and disposed in an inner chamber of the brake magnetic pole unit 34.

The rotation stopper mechanism includes the annular magnetic pole-bearing member 73, the stationary magnetic pole member 74, and the rotation stopper coil 75. The annular magnetic pole-bearing member 73 is secured to an end surface of the internal gear 50 which faces the motor 2. The stationary magnetic pole member 74 is placed away from the magnetic pole-bearing member 73. In other words, the stationary pole member 74 faces the magnetic pole bearing member 73 and is arranged in non-contact therewith. When excited, the rotation stopper coil 75 produces a magnetic field to magnetize the stationary magnetic pole member 74.

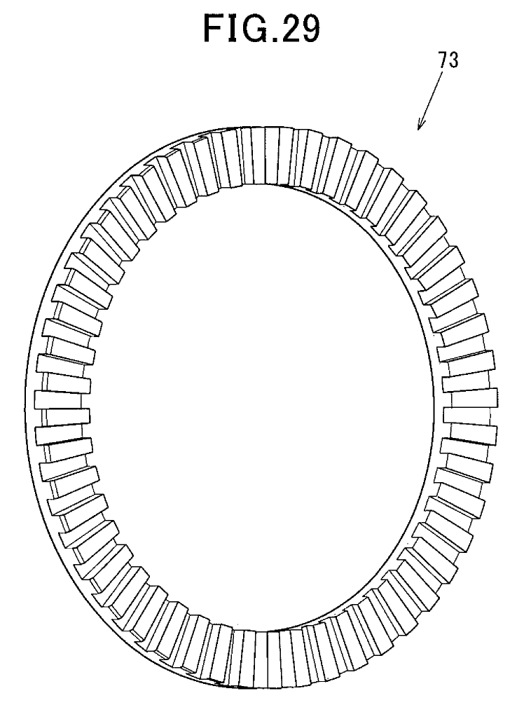

The magnetic pole-bearing member 73 is, as can be seen in FIG. 29, of a ring shape and made of a ferromagnetic material such as iron. The magnetic pole-bearing member 73 has the teeth arrayed successively in a circumferential direction thereof on the surface thereof which faces the stationary magnetic pole member 74. The stationary magnetic pole member 74 forms a magnetic path which has a rectangular traverse cross section with four sides: one (i.e., the left side, as viewed in FIG. 27) which faces the magnetic pole-bearing member 73 and opens in the opposite motor direction, one which faces radially inwardly and is closed, one which faces radially outwardly and is closed, and one (i.e., the right side, as viewed in FIG. 27) which faces the motor 2 and is closed. The stationary magnetic pole member 74 has teeth formed on a surface thereof which faces the magnetic pole-bearing member 73. The teeth are arrayed successively in a circumferential direction of the stationary magnetic pole member 74. The stationary magnetic pole member 74 is formed integrally with, for example the brake magnetic pole units 34 and fixedly secured to the motor partition wall 10.

The rotation stopper coil 75 is wound around a bobbin (not shown) and disposed in an inner chamber of the stationary magnetic pole member 74.

The operation of the starter 1 of the eighth embodiment will be described below.

The brake coil 50 and the motor 2 are excited in response to an engine start request.

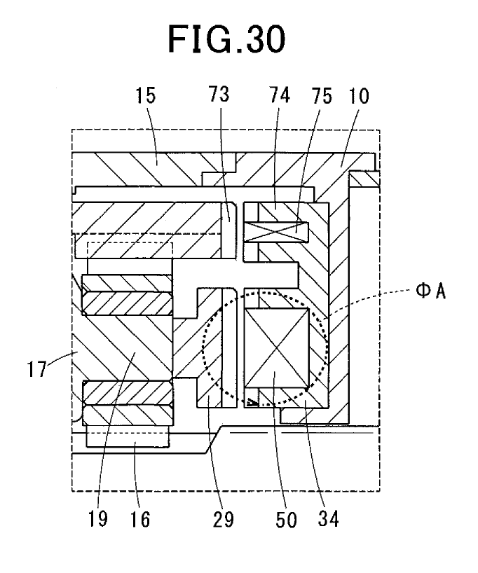

When the brake magnetic pole unit 34 is magnetized by the excitation of the brake coil 50, a magnetic flux OA, as illustrated in FIG. 30, is developed which flows between the brake magnetic pole units 34 and the brake plate 29. The magnetic flux OA will usually flow through an air gap between each of the teeth of the brake magnetic pole unit 34 and one of the teeth of the brake plate 29 where the magnetic resistance is the lowest between the brake magnetic pole unit 34 and the brake plate 29, so that a magnetic attraction is created between the mutually facing teeth of the brake magnetic pole unit 34 and the brake plate 29 to hold the brake plate 29 from rotating.

When the brake plate 29 is locked from rotating by the electromagnetic brake device, so that the planetary carrier 17 to which the brake plate 29 is secured is held from rotating, the torque, as produced by the motor 2, is transmitted to the internal gear 15. The internal gear 15, thus, rotates in a direction opposite a direction in which the motor 2 rotates.

The operation of the starter 1 in which the rotation of the internal gear 15 is transmitted to the pinion 5 through a pinion moving mechanism, so that the pinion 5 meshes with the ring gear of the engine is substantially the same as that in the first embodiment.

After the pinion 5 meshes with the ring gear, the brake coil 50 is deexcited, while the rotation stopper coil 75 is excited.

When the brake coil 50 is deenergized, the planetary carrier 17 is permitted to rotate, so that the torque of the motor 2 is inputted to the planetary carrier 17, so that the planetary carrier 17 rotates in the same direction as that in which the motor 2 rotates. The rotation of the planetary carrier 17 is then transmitted to the output shaft 3 through the clutch 4, so that the pinion 5 rotates together with the output shaft 3, thereby driving the ring gear to crank the engine.

During the cranking operation, a variation in torque of the engine may result in an increase in rotating speed of the ring gear relative to the pinion 5. In other words, the pinion 5 may be rotated by the ring gear. In this event, if the cam cylinder 42 is not locked from rotating, it causes the cam cylinder 42 to rotate in the same direction as that in which the motor 2 rotates, so that the force of thrust will be added to the pinion 5 rightward, as viewed in FIG. 27, thus resulting in a risk that the pinion 5 is disengaged from the ring gear of the engine.

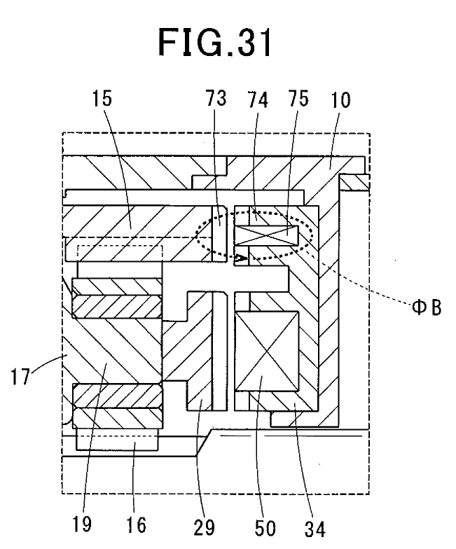

In order to alleviate the above problem, the starter 1 of the eighth embodiment is engineered to have the rotation stopper mechanism working to hold the internal gear 15 from rotating to lock the rotation of the cam cylinder 42. Specifically, when the rotation stopper coil 75 is excited to magnetize the stationary magnetic pole member 74, it produces, as illustrated in FIG. 31, a magnetic flux ΦB which flows between the stationary magnetic pole member 74 and the magnetic pole-bearing member 73. The magnetic flux ΦB will usually flow through an air gap between each of the teeth of the stationary magnetic pole member 74 and one of the teeth of the magnetic pole-bearing member 73 where the magnetic resistance is the lowest between the stationary magnetic pole member 74 and the magnetic pole-bearing member 73, so that a magnetic attraction is created between the mutually facing teeth of the stationary magnetic pole member 74 and the magnetic pole-bearing member 73 to hold the magnetic pole-bearing member 73 from rotating to lock the rotation of the internal gear 15 to which the magnetic pole-bearing member 73 is secured. Since the internal gear 15 is joined to the cam cylinder 42 through the engaging plate 46, the locking of the rotation of the internal gear 15 locks the rotation of the cam cylinder 42.

The starter 1 of the eighth embodiment is capable of moving the pinion 5 toward the ring gear of the engine without the use of the feed screw motion of the helical spline 28 mounted on the output shaft 3, thus offering substantially the same beneficial advantages as those in the first embodiment. The starter 1 is also equipped with the rotation stopper mechanism which works to lock the internal gear 15 from rotating while the engine is being cranked, thereby holding the cam cylinder 42 from rotating. This obviates the risk that the pinion 5 is disengaged from the ring gear of the engine when the rotating speed of the ring gear relatively exceeds that of the pinion 5 due to a variation in torque outputted by the engine.

The rotation stopper mechanism in the eighth embodiment may be used with the starter 1 of the first to seventh embodiments.

### Modifications

The first embodiment uses the AC motor 2, but may alternatively employ a DC motor equipped with a reversing circuit which serves to switch the DC motor from forward to reverse and vice versa.

The electromagnetic brake device, as described in the first, fifth, and seventh embodiments, has the friction plate 30 between the brake magnetic pole unit(s) 34 and the brake plate 29 (or the brake and clutch plate 53 in the fifth embodiment), but may omit the friction plate 30. Specifically, the friction plate 30 is used to ensure the stability of frictional engagement between itself and the brake plate 29 and thus may be omitted when the degree of friction between the brake plate 29 and the brake magnetic pole unit(s) 34 is developed which is great enough to produce the force of braking to lock the rotation of the brake plate 29 completely.

In the first embodiment, the bolts 32 are joined to the threaded holes formed in the dummy pins 24 to mechanically support the brake plate 29, but however, the brake plate 29 may be retained using the planetary gear pins 18 instead of the dummy pins 24. The dummy pins 24 are not essential parts in the invention and thus may be omitted.

In the third embodiment, the hollow cylinder 49 has the straight grooves 43 formed therein, while the cam cylinder 42 has the cam grooves 41 formed therein, but however, the hollow cylinder 49 may be designed to have the cam grooves 41, while the cam cylinder 42 may have the straight grooves 43.

The first embodiment refers to the example where the starter 1 is used to start the engine. For instance, in automotive vehicles equipped with an idle-stop system (also called an automatic engine stop and restart system), the pinion 5 of the starter 1 may be kept engaged with the ring gear of the engine after the engine is automatically shut down. In this case, the motor 2 may be excited in response to an engine restart request to quickly start the engine again. This results in a decrease in time required to restart the engine.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A starter comprising:
an electric motor which is supplied with electrical power to produce torque;
a power split device which works to distribute the torque inputted from the motor to a first power transmission system and a second power transmission system, the power split device having a first output from which the torque distributed to the first power transmission system is outputted and a second output from which the torque distributed to the second power transmission system is outputted;
an output shaft which is rotated by the torque which is outputted from the first output and transmitted to the output shaft;
a pinion which engages an outer periphery of the output shaft through a spline and is movable on the output shaft in an axial direction thereof;
a pinion thrust mechanism which includes a cam cylinder which is rotated by the torque which is outputted from the second output and transmitted to the cam cylinder, the pinion thrust mechanism working to convert rotational motion of the cam cylinder into linear motion of the pinion; and
an electromagnetic brake device which includes a brake plate which is made of ferromagnetic material and is joined to the first output of the power split device, the electromagnetic brake device working to use magnetic force to hold the brake plate from rotating.

2. A starter as set forth in claim 1, wherein when the electromagnetic brake device locks the brake plate from rotating, the power split device distributes the torque of the motor to the second output, so that the second output rotates in a direction opposite a direction in which the motor rotates, and wherein when the second output rotates in the direction opposite the direction in which the motor rotates, the pinion thrust mechanism applies a force of thrust to the pinion to move the pinion toward a ring gear of an engine.

3. A starter as set forth in claim 1, wherein the power split device is implemented by a planetary gear train which includes a sun gear mounted on a rotating shaft of the motor, an internal gear arranged coaxially with an axis of rotation of the sun gear to be rotatable, planetary gears which mesh with the sun gear and the internal gear to be rotatable and orbitable, and a planetary carrier, wherein the planetary carrier serves as the first output, and the internal gear serves as the second output.

4. A starter as set forth in claim 1, wherein the power split device is implemented by a differential gear unit which includes a first large bevel gear which works as a driving bevel gear and is rotated by the motor, a second large bevel gear which works as a trailing bevel gear and is rotatably arranged to face the first large bevel gear in an axial direction thereof, small bevel gears which mesh with the first and second large bevel gears to be rotatable and orbitable, and a bevel gear holder which retains the small bevel gears to be rotatable about rotating shafts, and wherein the bevel gear holder works as the first output, and the second large bevel gear serves as the second output.

5. A starter as set forth in claim 1, further comprising a rotation stopper mechanism which includes a magnetic pole-bearing member made of ferromagnetic material to which the torque of the motor, as delivered from the second output, is transmitted and which rotates together with the cam cylinder, the rotation stopper mechanism working to use a magnetic force to hold the magnetic pole-bearing member from rotating to lock rotation of the cam cylinder, wherein when the pinion meshes with a ring gear of an engine to crank the engine through the pinion thrust mechanism, the rotation stopper mechanism holds the cam cylinder of the pinion thrust mechanism from rotating.

6. A starter as set forth in claim 3, further comprising an electromagnetic clutch which includes a rotating motor plate which is made of ferromagnetic material and joined to a rotating shaft of the motor to be rotatable together with the rotating shaft and a clutch plate which is formed integrally with the brake plate or made of a discrete member separate from the brake plate and joined to the planetary carrier, the electromagnetic clutch working to magnetically couple between the rotating motor plate and the clutch plate, and wherein when the electromagnetic brake device permits the brake plate to rotate, and the electromagnetic clutch magnetically couples the rotating motor plate and the clutch plate together, the power split device works to split and distribute the torque of the motor to the first output and the second output, so that the second output rotates in the same direction as that in which the motor rotates.

7. A starter as set forth in claim 1, wherein the electromagnetic brake device includes a brake magnetic pole unit, a permanent magnet, and a brake release coil, the brake magnetic pole unit being placed to face the brake plate, the permanent magnet working to magnetize the brake magnetic pole unit, when excited, the brake release coil producing a magnetic field to cancel a magnetic field which is produced by the permanent magnet and exerted on the brake magnetic pole unit, and wherein when the brake release coil is deexcited, the brake plate is attracted to the brake magnetic pole unit and held from rotating with the aid of frictional force.

8. A starter as set forth in claim 1, wherein the electromagnetic brake device includes a brake magnetic pole unit and a brake coil, the brake magnetic pole unit being placed to face the brake plate, when excited, the brake coil producing a magnetic field to magnetize the brake magnetic pole unit, and wherein when the brake coil is excited, the brake plate is attracted to the brake magnetic pole unit and held from rotating with the aid of frictional force.

9. A starter as set forth in claim 1, wherein the electromagnetic brake device includes a brake cylindrical portion which is defined by a portion of the brake plate which extends in an axial direction of the brake plate having magnetic hysteresis characteristics, a brake magnetic pole unit which covers the brake cylindrical portion in contactless way from outside and inside the brake cylindrical portion in a radial direction of the brake magnetic pole unit, and a brake coil which produces a magnetic field to magnetize the brake magnetic pole unit when the brake coil is excited, and wherein the brake coil is excited to produce a magnetic braking force between the brake magnetic pole unit and the brake cylindrical portion, thereby holding the brake plate from rotating.

10. A starter as set forth in claim 1, wherein the electromagnetic brake device include a brake coil and an annular magnetic core, the annular magnetic core including a plurality of magnetic pole claws arranged in a circumferential direction thereof, when excited, the brake coil producing a magnetic field to magnetize the magnetic pole claws to have N-poles and S-poles arranged alternately, and wherein the brake plate includes a waved ring which is disposed to face an inner circumference of the magnetic claws and has a corrugated circumference defined by troughs and crests arranged successively and alternately, when the brake coil is excited, it producing holding torque between the waved ring and the magnetic pole claws which are magnetized, thereby holding the brake plate from rotating.

11. A starter as set forth in claim 1, wherein the electromagnetic brake device includes a brake magnetic pole unit which faces the brake plate and is placed in non-contact therewith and a brake coil which, when excited, produces a magnetic field to magnetize the brake magnetic pole unit, and wherein the brake plate and the brake magnetic pole unit have surfaces which are opposed to each other and on each of which a plurality of protrusions are arranged successively in a circumferential direction thereof, when the brake coil is excited, a magnetic attraction is developed between each of the protrusions of the brake plate and one of the protrusions of the brake magnetic pole unit to hold the brake plate from rotating.

12. A starter as set forth in claim 5, wherein the rotation stopper mechanism includes a stationary magnetic pole member which faces the magnetic pole-bearing member and is arranged in non-contact therewith and a rotation stopper coil which, when excited, produces a magnetic field to magnetize the stationary magnetic pole member, and wherein the magnetic pole-bearing member and the stationary magnetic pole member have surfaces which are opposed to each other and on each of which a plurality of protrusions are arranged successively in a circumferential direction thereof, when the rotation stopper coil is excited, a magnetic attraction is developed between each of the protrusions of the magnetic pole-bearing member and one of the protrusions of the stationary magnetic pole member to hold the magnetic pole-bearing member from rotating.

13. A starter as set forth in claim 6, wherein the electromagnetic clutch includes a rotating clutch magnetic pole unit, a clutch magnetic pole unit, and a clutch coil, the rotating clutch magnetic pole unit being disposed integrally with the rotating motor plate and facing the clutch plate, the clutch magnetic pole unit facing the rotating clutch magnetic pole unit and being disposed on an opposite side of the rotating clutch magnetic pole unit to the clutch plate, when excited, the clutch coil producing a magnetic field to magnetize the clutch magnetic pole unit, and wherein when the clutch coil is excited, the clutch plate is attracted to the clutch magnetic pole unit into contact with the rotating clutch magnetic pole unit, thereby establishing a magnetic connection between the clutch plate and the rotating motor plate.

14. A starter as set forth in claim 6, wherein the electromagnetic clutch includes a clutch cylindrical portion, a rotating clutch magnetic pole unit, clutch magnetic pole unit, and a clutch coil, the clutch cylindrical portion being defined by a portion of the clutch plate which extends in an axial direction of the clutch plate having magnetic hysteresis characteristics, the rotating clutch magnetic pole unit which is disposed integrally with the rotating motor plate and covers the clutch cylindrical portion in contactless way from outside and inside the clutch cylindrical portion in a radial direction of the rotating clutch magnetic pole unit, the clutch magnetic pole unit facing the rotating clutch magnetic pole unit, when excited, the clutch coil producing a magnetic field to magnetize the clutch magnetic pole unit, and wherein when the clutch coil is excited, the clutch plate is magnetically coupled with the rotating motor plate by a magnetic attraction created between the rotating clutch magnetic pole unit which is magnetized through the clutch magnetic pole unit and the clutch cylindrical portion.

15. A starter as set forth in claim 1, wherein the pinion thrust mechanism includes said cam cylinder, a fixing member, an engaging pin, and a transmission member, the cam cylinder having a cylindrical portion which extends over an outer circumference of the pinion in an axial direction thereof and also has formed therein a cam groove, the cam groove having a starting end and a terminal end and extending from the starting end to the terminal end in a spiral form in a circumferential direction thereof, the fixing member being disposed outside or inside said cylindrical portion in a radial direction of the cylindrical portion and held from moving in a radial and a circumferential direction of the cylindrical portion, the fixing member having formed therein a straight groove which traverses the cam groove in an axial direction of the cylindrical portion, the engaging pin being disposed in an intersection of the cam groove and the straight groove in engagement with the cam groove and the straight groove, the transmission member working to transmit movement of the engaging pin which travels in the straight groove in the axial direction with rotation of the cam cylinder to the pinion.

16. A starter as set forth in claim 1, wherein the pinion thrust mechanism includes said cam cylinder, a fixing member, and an engaging pin, and a transmission member, the cam cylinder 42 having a cylindrical portion which extends over an outer circumference of the pinion in an axial direction thereof and has formed therein a straight groove 43 which extends in an axial direction of the cylindrical portion, the fixing member being disposed outside or inside said cylindrical portion in a radial direction of the cylindrical portion and held from moving in an axial and a circumferential direction of the cylindrical portion, the fixing member having formed therein a cam groove which obliquely intersects with the straight groove, the engaging pin being disposed in an intersection of the straight groove and the cam groove in engagement with the straight groove and the cam groove, the transmission member working to transmit movement of the engaging pin which travels in the straight groove in the axial direction with rotation of the cam cylinder to the pinion.

17. A starter as set forth in claim 15, wherein the fixing member is implemented by a starter housing which has a cylindrical inner peripheral surface, the cylindrical inner peripheral surface facing an outer peripheral surface of the cylindrical portion and having said straight groove formed therein.

18. A starter as set forth in claim 16, wherein the fixing member is implemented by a starter housing which has a cylindrical inner peripheral surface, the cylindrical inner peripheral surface facing an outer peripheral surface of the cylindrical portion and having said cam groove formed therein.

19. A starter as set forth in claim 15, wherein the fixing member is implemented by a cylinder which is retained by a starter housing and held from moving in an axial and a circumferential direction of the cylinder, the cylinder having said straight groove formed therein.

20. A starter as set forth in claim 16, wherein the fixing member is implemented by a cylinder which is retained by a starter housing and held from moving in an axial and a circumferential direction of the cylinder, the cylinder having said cam groove formed therein.

21. A starter as set forth in claim 15, wherein said transmission member holds the engaging pin, is rotatable relative to the pinion, and held from rotating in an axial direction of the pinion.

22. A starter as set forth in claim 1, wherein the pinion engages a helical spine provided on said output shaft.

23. A starter as set forth in claim 1, wherein the pinion engages a straight spine provided on said output shaft.

24. A starter as set forth in claim 1, wherein the motor is a DC motor or an AC motor which is rotatable from forward to reverse and vice versa.

25. A starter as set forth in claim 1, wherein the motor is a DC commutator motor.

26. A starter as set forth in claim 16, wherein said transmission member holds the engaging pin, is rotatable relative to the pinion, and held from rotating in an axial direction of the pinion.
